(19) United States
(12) Patent Application Publication
(10) Pub. No.: US 2006/0136259 A1
(43) Pub. Date: Jun. 22, 2006

(54) Multi-dimensional analysis of medical data

(75) Inventors: Allison Leigh Weiner, Milwaukee, WI (US); Gopal B. Avinash, New Berlin, WI (US)

Correspondence Address: Patrick S. Yoder;FLETCHER YODER, P.O. Box 692289, Houston, TX, 77269-2289, US

(73) Assignee: General Electric Company

(21) Appl. No.: 11/015,526

(22) Filed: Dec. 17, 2004

(51) Int. Cl. G06Q 10/00

(52) U.S. Cl. 705/2

(57) ABSTRACT

A technique is disclosed for identifying medical data entities and for analyzing them for classification in accordance with a defined domain definition. The domain definition may be user-defined and may include a plurality of logical associations by which the data entities are classified. A one-to-many classification of the entities facilitates complex analysis of the data. The data entities may be analyzed to recognize relationships between them for rendering patient care, identifying health conditions in populations, and so forth.

### CROSS REFERENCE TO RELATED APPLICATIONS

This application is a continuation-in-part of U.S. patent application Ser. No. 10/323,086, entitled “Integrated Medical Knowledge Base Interface System and Method”, filed Dec. 18, 2002, which is herein incorporated by reference.

### BACKGROUND

The invention relates generally to the field of data classification, mapping and analysis. More specifically, the invention relates to techniques for computer-assisted definition of relevant domains and to the automated classification of documents and other data entities based upon such definitions.

A wide array of techniques have been developed and are currently in use for identifying data entities of relevance to a particular field of interest. As used herein, “data entities” may include any type of digitized data capable of being identified, analyzed and classified by automated techniques. Such entities may include, for example, textual documents, image files, audio files, waveform data, and combinations of these, to mention only a few.

Existing data entity identification, analysis and classification techniques are often designed to identify relevant documents and other data items and, to some degree, to collect either the items themselves or relevant portions. Common search engines, for example, allow for Boolean searches of words or other criteria. The searches may be executed on the documents themselves, or on portions of documents, indexed documents, and so forth. Certain search tools employ tagging of documents with relevant terms for similar purposes. Results are typically returned as listings, sometimes with links to the documents. Common techniques also employ rankings of relevancy of documents.

While such tools are quite useful for many searches, there is a need for improved tools which can perform more useful searches and classification. There is a particular need for a tool which can permit extensive analysis, structuring, mapping and classification of data entities based upon more complete and user-directed definition of relevant domains and classifications within the domains. Moreover, there is a need for a tool which can search and classify documents, images, text files, audio files, and so forth based upon a combination of criteria.

### BRIEF DESCRIPTION

The present invention provides novel techniques for data entity identification, analysis, structuring, mapping and classification, and for the subsequent use of such analyzed data designed to respond to such needs. The technique is said to be “domain-specific” in that it facilitates the definition of a “domain” by a user. The domain may pertain to any conceptual field whatsoever that is defined by the user, along with conceptual subdivisions or levels within the domain, and eventually particular attributes of data entities that may be located. The domain, then, essentially defines a conceptual framework according to which data entities may be identified, structured, mapped and classified.

In certain embodiments, the technique is applied to specific types of data entities, such as documents. In certain embodiments, the documents may be documents pertaining to patient records, medical articles, disease descriptions, annotations, and many other data entities that may fully or partially comprise data representative of text.

In other embodiments, the data entities may be other documents that may include attributes such as words and phrases of interest that may likely be found, corresponding to the conceptual framework of the domain definition. In still other applications, the data entities may include images, such as medical diagnostic images in certain examples, along with text that either is a part of the image file itself or may be appended or in some other way associated with the image file. The techniques, then, permit definition of the relevant domain, along with a conceptual framework for the domain and the attributes of data entities which may fit within the framework.

From this framework, then, a knowledge base or integrated knowledge base (IKB) may be established, and subsequent searches, analysis, mapping and classification, and use of the entities may be made based upon the IKB or based upon new searches performed in a different database.

A range of user-configurable displays are also provided to facilitate user analysis and interaction with the domain definition, domain refinement, statistical or other analysis of the data entities, or with the data entities themselves.

In certain aspects and implementations, the data entities may include prescribeable and controllable resources, such as various clinical tests and examinations, as well as other data resources, such as publicly available information or information that does not require immediate patient interaction with the health care system.

Moreover, the invention provides a range of applications for data entities that has been identified, analyzed and classified. The applications range from the provision of health care to particular individuals, to analysis of evolving diseases in populations. Other applications might include modeling of disease states, improved diagnosis and treatment, improved recommendations for testing and procedures, and so forth.

The invention contemplates methods for carrying out such domain definition and data entity analysis, structuring, mapping and classification, as well as systems and software for performing such functionality.

### DRAWINGS

These and other features, aspects, and advantages of the present invention will become better understood when the following detailed description is read with reference to the accompanying drawings in which like characters represent like parts throughout the drawings, wherein:

FIG. 1 is a diagrammatical overview of a data entity identification, structuring, mapping and classification system in accordance with aspects of the present techniques;

FIG. 2 is a flow diagram of exemplary domain definition logic which may be employed in a system such as that illustrated in FIG. 1;

FIG. 3 is a flow diagram of entity processing logic based upon a domain definition;

FIG. 4 is a diagrammatical representation of exemplary mapping of data entities performed through the logic of FIG. 3;

FIG. 5 is a diagrammatical representation of related domains and domain levels that may be implemented in accordance with aspects of the present techniques;

FIG. 6 is a diagrammatical representation of a multi-level domain definition implemented to facilitate structuring, mapping, classification and analysis of data entities;

FIG. 7 is a representation of an exemplary domain definition template for use with a programmed computer in accordance with aspects of the present technique;

FIG. 8 is a representation of an exemplary template for defining axes and labels of the domain defined by the template of FIG. 7;

FIG. 9 is an exemplary interface for defining data entity attributes for axes and labels of a domain;

FIG. 10 is a flow chart illustrating exemplary logic for search and classification of data entities, and for establishment of an IKB based upon such search and classification;

FIG. 11 is a diagrammatical representation of how a collection of entities may be mapped into an IKB using a domain definition and rules in accordance with the present techniques;

FIG. 12 is a diagrammatical representation of certain processing steps that may be performed for analysis and classification of data entities;

FIG. 13 is a diagrammatical representation of one exemplary process for identifying relevant records or data entities in a known field, such as an IKB;

FIG. 14 represents one exemplary representation of an analyzed set of data entities, such as textual documents with highlighting based upon a domain definition as a conceptual framework;

FIG. 15 is a further representation of analysis performed on a set of data entities to identify correspondence between attributes or portions of the conceptual framework of the domain definition found in a set of data entities;

FIG. 16 is an exemplary representation of analysis of a series of data entities showing overlap or intersection of correspondence between entities having specific attributes;

FIG. 17 is a further exemplary representation of analysis performed on a series of records or data entities for a portion of a domain definition or analytical or conceptual framework;

FIG. 18 is a further exemplary representation of analysis performed on a series of data entities showing classification by other criteria, such as by ownership;

FIG. 19 is a further exemplary representation of analysis and classification of data entities by the records themselves (i.e., the data entities);

FIG. 20 is a further exemplary representation of data analyzed for a series of data entities, indicating cumulative counts of entities by the conceptual framework of the domain definition;

FIG. 21 is a further representation of an exemplary analysis of data entities similar to that illustrated in FIG. 20, but showing exemplary additional displays of data that may be obtained based upon the analyzed and classified data entities;

FIG. 22 is a diagrammatical representation of a further interactive representation of analysis and classification of data entities based upon a domain definition and conceptual framework associated therewith;

FIG. 23 is a diagrammatical representation of the domain definition, search, analysis, mapping and classification techniques applied to image data files and associated text files for establishment of a database of such files, such as an IKB;

FIG. 24 is a further diagrammatical representation of exemplary workflow for analysis, mapping and classification of image and text files for classification and mapping of the files in accordance with aspects of the present technique; and

FIG. 25 is a representation of an exemplary display of a series of summaries of the analysis of image and text files following the processes of FIGS. 23 and 24.

### DETAILED DESCRIPTION

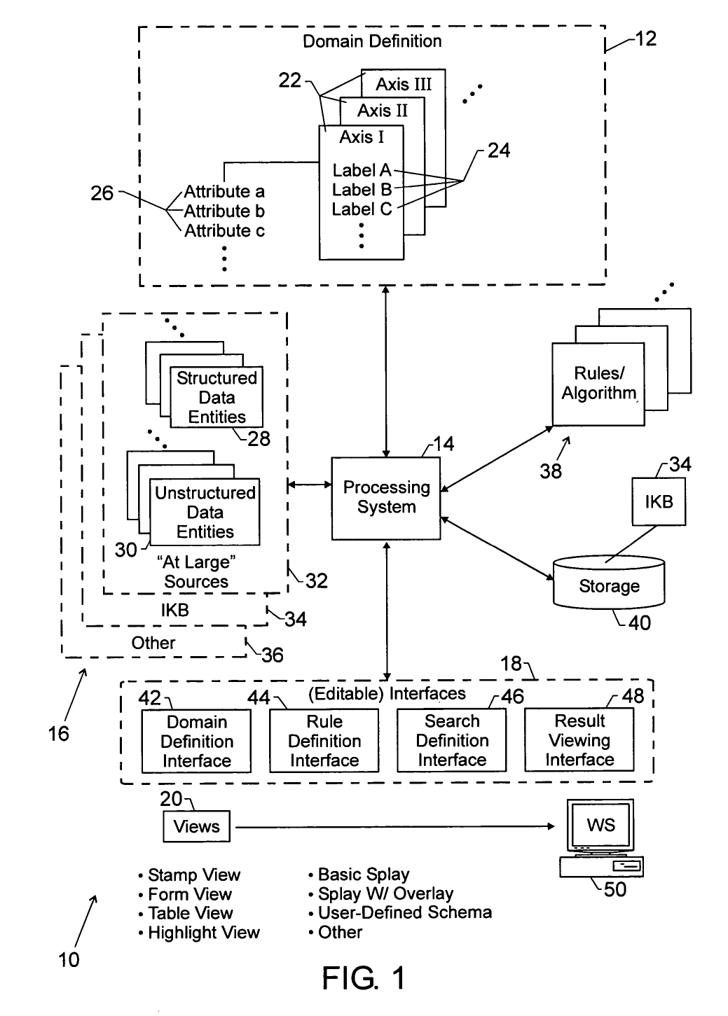

Turning to the drawings and referring first to FIG. 1, a data entity mapping system 10 is illustrated diagrammatically for establishing a domain definition, and for searching, analyzing, structuring, mapping and classifying data entities in accordance with the definition. In the embodiment illustrated in FIG. 1, the domain definition is designated by reference numeral 12. As described in greater detail below, the domain definition may relate to any relevant field, such as technical fields within a medical practice or health care system. The domain definition may be established in accordance with the techniques described below, and may generally be thought of a conceptual framework of logically subdivided portions of the relevant field. Each portion may be further subdivided into any number of conceptual levels. The levels are eventually associated with attributes likely to be found in the data entities, permitting their identification, analysis, structuring, mapping and classification.

The domain definition 12 is linked to a processing system 14 which utilizes the domain definition for identifying data entities from any of a range of data resources 16. The processing system 14 will generally include one or more programmed computers, which may be located at one or more locations. The domain definition itself may be stored in the processing system 14, or the definition may be accessed by the processing system 14 when called upon to search, analyze, structuring, mapping or classify the data entities. To permit user interface with the domain definition, and the data resources and data entities themselves, a series of editable interfaces 18 are provided. Again, such interfaces may be stored in the processing system 14 or may be accessed by the system as needed. The interfaces generate a series of views 20 about which more will be said below. In general, the views allow for definition of the domain, refinement of the domain, analysis of data entities, viewing of analytical results, and viewing and interaction with data entities themselves.

Returning to the domain definition 12, in the present discussion, the terms “access,” “label,” and “attribute” are employed for different levels of the conceptual framework represented by the domain definition. As will be appreciated by those skilled in the art, any other terms may be used. In general, the axes of the definition represent conceptual subdivisions of the domain. The axes may not necessarily cover the entire domain, and may, in fact, be structured strategically to permit analysis and viewing of certain aspects of the data entities in particular levels, as discussed below. The axes, designated at reference numeral 22, are then subdivided by the labels 24. Again, any suitable term may be used for this additional level of conceptual subdivision. The labels are generally are conceptual portions of the respective axis, although the labels may not cover the full range of concepts assignable to the axis. Moreover, the present techniques do not exclude overlaps, redundancies, or, on the contrary, exclusions between labels of one axis and another, or indeed of axes themselves.

Each label is then associated with attributes 26. Again, attributes may be common between labels or even between axes. In general, however, strategic definition of the domain permits one-to-many mapping and classification of individual data entities in ways that allow a user to classify the data entities. Thus, some distinctions between the axes, the labels and the attributes are useful to allow for distinction between the data entities.

Furthermore, by way of example only, the present techniques may be applied to identification of textual documents, as well as documents with other forms and types of data, such as image data, audio data, waveform data, and so forth, as discussed below. By way of further example, the technique may be applied to identifying data relating to particular patients, institutions, equipment, disease states, treatments, known populations, testing and analysis techniques, imaging techniques, and so forth, in a particular technical field or domain of interest. Within such domains, a range of individual classifications may be devised, which may follow traditional classifications, or may be defined completely by the user based upon particular knowledge or interest. Within each of the individual axes, then, individual subdivisions of the classification may be implemented. As described in greater detail below, many such levels of classification may be implemented. Finally, because the documents may be primarily textual in nature, individual attributes 26 may include particular words, word strings, phrases, and the like. In other types of data entities, attributes may include features of interest in images, portions of audio files, portions or trends in waveforms, and so forth. The domain definition, then, permits searching, analysis, structuring, mapping and classification of individual data entities by the particular features identifiable within and between the entities.

As will be discussed in greater detail below, however, while the present techniques provide unprecedented tools for analysis of textual documents, the invention is in no way limited to application with textual data entities only. The techniques may be employed with data entities such as images, audio data, waveform data, and data entities which include or are associated with one another having one or more of these types of data (i.e., text and images, text and audio, images and audio, text and images and audio, etc.).

Based upon the domain definition, the processing system 14 accesses the data resources 16 to identify, analyze, structure, map and classify individual data entities. A wide range of such data entities may be accessed by the system, and these may be found in any suitable location or form. For example, the present technique may be used to identify and analyze structured data entities 28 or unstructured entities 30. Structured data entities 28 may include such structured data as bibliography content, pre-identified fields, tags, and so forth. Unstructured data entities may not include any such identifiable fields, but may be, instead, “raw” data entities for which more or different processing may be in order. Moreover, such structured and unstructured data entities may be considered from “at large” sources 32, or from known and pre-established databases such as an integrated knowledge base (IKB) 34. As used herein, the term “at large” sources include any sources that are not pre-organized, typically by the user into an IKB such at large sources may be found via the Internet, libraries, professional organizations, user groups, or from any other resource whatsoever.

The IKB, on the other hand, may include data entities which are pre-identified, analyzed, structured, mapped and classified in accordance with the conceptual framework of the domain definition. The establishment of an IKB, as discussed in greater detail below, is particularly useful for the further and more rapid analysis and reclassification of entities, and for searching entities based upon user-defined search criteria. However, it should be borne in mind that the same or similar search criteria may be used for identifying data entities from at large sources, and the present technique is not intended to be limited to use with a pre-defined IKB.

Finally, as illustrated in FIG. 1, any other sources of data entities may be drawn upon by the processing system 14 as represented generally by reference numeral 36. These other sources may include sources that become available following establishment of the domain and classification, such as newly established or newly subscribed to resources. It should also be borne in mind that such new resources may come into existence at any time, and the present technique provides for their incorporation into the classification system, and indeed for refinement of the classification system itself to accommodate such new data entities.

The present techniques provide several useful functions that should be considered as distinct, although related. First, “identification” of data entities relates to the selection of entities of interest, or of potential interest. This is typically done by reference to the attributes of the domain definition, and to any rules or algorithms implemented to work in conjunction with the attributes. “Analysis” of the entities entails examination of the features defined by the data. Many types of analysis may be performed, again based upon the attributes of interest, the attributes of the entities and the rules or algorithms upon which structuring, mapping and classification will be based. Analysis is also performed on the structured and classified data entities, such as to identify similarities, differences, trends, and even previously unrecognized correspondences.

“Structuring” as used herein refers to the establishment of the conceptual framework or domain definition. In the data mining field, the term “structuring” and the distinction between “structured” and “unstructured” data may sometimes be used (e.g., as above with respect to the structured and unstructured entities represented in FIG. 1). Such “structure” may be thought of as implementing a particular analytical system on and within certain data entities. Thus, a document may be subdivided into a title, abstract, and subparts. Within each of these, however, the data may remain essentially unstructured. The present techniques permit such structure to be used, altered or even discarded, depending upon the particular conceptual framework of the domain definition. Such structuring may entail translation, formatting, tagging, or otherwise transforming the data to a form that is more readily searched, analyzed, compared and classified. By way of example, such structuring may include conversion of the data into a particular type of file or format, such as through use of a markup language, such as XML.

“Mapping” of the entities involves relation of the attributes of the domain definition to the features and attributes of the data entities. Such mapping may be thought of as a process of applying the domain definition to the data of each entity, in accordance with the attributes of the domain definition and the rules and algorithms employed. Although highly related, mapping is distinguished from “classification” in the present context. Classification is the assignment of a relationship between the subdivisions of the conceptual framework of the domain definition (e.g., via the attributes of the axes and labels) and the data entities. In the present context, reference is made to one-to-many mapping and to one-to-many classification, with mapping being the process for arriving at the classification based upon the structural system of the domain definition.

The resulting process may be distinguished from certain existing techniques, such as data mining, taxonomy, markup languages, and simple search engines, although certain of these may be used for the subprocesses implemented here. For example, typical data mining identifies relationships or patters in data from a data entity standpoint, and not based upon a structure established by a domain definition. Data mining generally does not provide one-to-many mappings or classifications of entities. Taxonomies impose a unique classification of entities by virtue of the breakdown of the categories defining the taxonomy. Markup languages, while potentially useful for structuring entities, are not well suited for one-to-many mapping or classification, and generally provide “structure” within the entities based upon the tags or other features of the language. Similarly, simple search techniques typically only return listings of entities that satisfy certain search criteria, but provide no mapping or classification of the entities as provided herein.

The processing system 14 also draws upon rules and algorithms 38 for analysis, structuring, mapping and classification of the data entities. As discussed in greater detail below, the rules and algorithms 38 will typically be adapted for specific types of data entities and indeed for specific purposes (e.g., analysis and classification) of the data entities. For example, the rules and algorithms may pertain to analysis of text in textual documents or textual portions of data entities. The algorithms may provide for image analysis for image entities or image portions of entities, and so forth. The rules and algorithms may be stored in the processing system 14, or may be accessed as needed by the processing system. For example, certain of the algorithms may be quite specific to various types of data entities, such as diagnostic image files. Sophisticated algorithms for the analysis and identification of features of interest in image may be among the algorithms, and these may be drawn upon as needed for analysis of the data entities.

The data processing system 14 is also coupled to one or more storage devices 40 for storing results of searches, results of analyses, user preferences, and any other permanent or temporary data that may be required for carrying out the purposes of the analysis, structuring, mapping and classification. In particular, storage 40 may be used for storing the IKB 34 once analysis, structuring, mapping and classification have been completed on a series of identified data entities. Again, additional data entities may be added to the IKB over time, and analysis and classification of data entities in the IKB may be refined and even changed based upon changes in the domain definition, the rules applied for analysis and classification, and so forth.

A range of editable interfaces may be envisaged for interacting with the domain definition, the rules and algorithms, and the entities themselves. By way of example only, as illustrated in FIG. 1, for such interfaces are presently contemplated. These may include a domain definition interface 42 for establishing the axes, labels and attributes of the domain. A rule definition interface 44 may be provided for defining particular rules to be used, or links to external rules and algorithms. A search definition interface 46 is provided for allowing users to search, analyze and classify data entities either from at large sources or an IKB, and various result viewing interfaces 48 are contemplated for illustrating the results of analysis of one or more data entities. The interfaces will typically be served to the user by a workstation 50 which is linked to the processing system 14. Indeed, the processing system 14 may be part of a workstation 50, or may be completely remote from the workstation and linked by a suitable network. Many different views may be served as part of the interfaces, including views enumerated in FIG. 1, and designated a stamp view, a form view, a table view, a highlight view, a basic spatial display (splay), a splay with overlay, a user-defined schema, or any other view. It should be borne in mind that these are merely exemplary reviews of analysis and classification, and many other views or variants of these views may be envisaged.

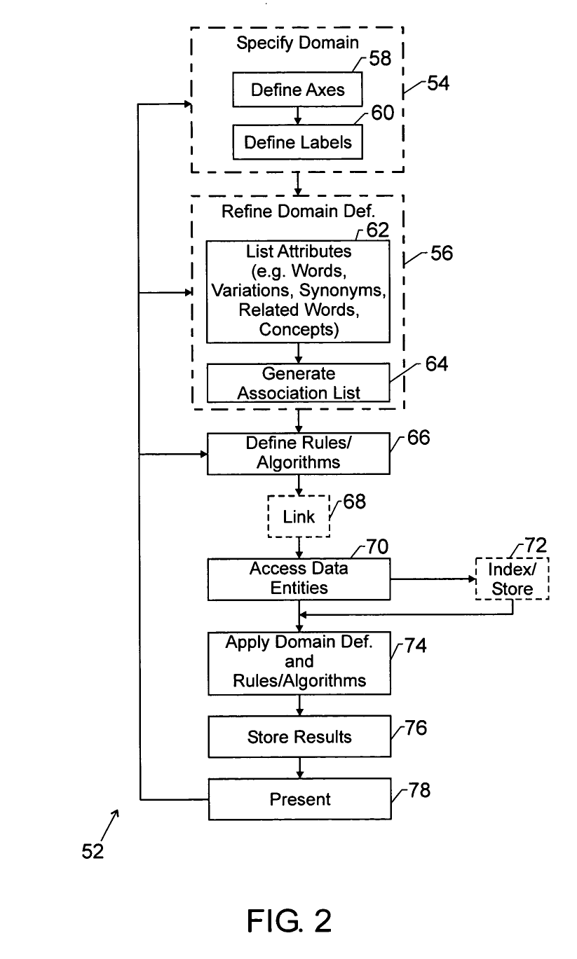

As noted above, the present techniques provide for user-definition and refinement of the conceptual framework represented by the domain definition. FIG. 2 illustrates exemplary steps in defining the conceptual framework of a domain. The overall logic, designated generally by reference numeral 52 includes general specification of the domain in a first phase 54, followed by refinement of the domain definition in a second phase 56. The specification of the domain 54 may include a range of steps, such as a definition of domain axes 58 and definition of labels 60 within each axis. As discussed above, the axes generally represent conceptual portions of the domain broken down in any suitable fashion defined by the user. The labels, in turn, represent conceptual breakdown of the individual axes. The labels, and indeed the axes, may be thought of as conceptual sub-classification levels. As discussed in greater detail below, certain of the levels may be redundant or lower levels may also be redundant with higher levels to permit “conceptual zooming” within the domain. That is, particular labels may also be listed as axes of the domain, permitting analysis and visualization of the bases for particular classifications of data entities.

Following specification of the domain, the domain may be further refined in phase 56. Such refinement may include listing attributes of the individual labels of each axis. In general, these attributes may be any feature of the data entities which may be found in the data entities and which facilitate their identification, analysis, structuring, mapping or classification. As indicated in FIG. 2, for documents, such entities may include words, variations on words and terms, synonyms, related words, concepts, and so forth. These may be simply listed for each label as discussed in greater detail below. Based upon the listed attributes, an association list may be generated as indicated at step 64. This association list effectively represents the collection of attributes to be associated with each label and axis.

Following definition of the domain, the rules and algorithms to be applied for the search, analysis, structuring, mapping and classification of specific data entities are identified and defined at step 66. These rules and algorithms may be defined by the user along with the domain. Such rules and algorithms may be as simple as whether and how to identify words and phrases (e.g., whether to search a whole word or phrase, proximity criteria, and so forth). In other contexts, much more elaborate algorithms may be employed. For example, even in the analysis of textual documents, complex text analysis, indexing, classification, tagging, and other such algorithms may be employed. In the case of image data entities, the algorithms may include algorithms that permit the identification, segmentation, classification, comparison and so forth of particular regions or features of interest within images. In the medical diagnostic context, for example, such algorithms may permit the computer-assisted diagnosis of disease states, or even more elaborate analysis of image data. Moreover, the rules and algorithms may permit the separate analysis of text and other data, including image data, audio data, and so forth. Still further, the rules and algorithms may provide for a combination of analysis of text and other data.

As discussed in greater detail below, the present techniques thus provide unprecedented liberty and breadth in the types of data that can be analyzed, and the classification of data entities based upon a combination of algorithms for text, image, and other types of data contained in the entities. At step 68, optionally, links to such rules and algorithms may be provided. Such links may be useful, for example, where particular data entities are to be located, but complex, evolving, or even new algorithms are available for their analysis and classification. Many such links may be provided, where appropriate, to facilitate classification of individual data entities once identified, and based upon user-input search criteria.

At step 70 the data entities are accessed. The data entities, again, may be found in any suitable location, including at large sources and known or even pre-defined knowledge basis and the like. The present techniques may extend to acquisition or creation of the data entities themselves, although the processing illustrated in FIG. 2 assumes that the data entities are already in existence. At step 72, optionally, the data entities may be indexed and stored. As will be appreciated by those skilled in the art, such indexing permits very rapid subsequent processing of the data entities. Such indexing may be particularly suitable for situations in which the data entities are to be accessed again and where the original entities are either unstructured or semi-structured, or even contain raw data (e.g., raw text). Where such indexing is performed, the indexed entities are typically stored at step 72 for later access, analysis, mapping and classification. Also, as noted above, even for entities and portions of entities that are structured or partially structured, the domain definition may utilize such structure (where, for example the existing structure within the entity corresponds to the structural system of the domain definition), or may restructure or further structure the data, or even disregard the existing data structure of the entity.

At step 74 in FIG. 2, the domain definition and the associated rules and algorithms are applied to the accessed data entities. Based upon the domain definition and the rules and algorithms, specific data entities are identified, analyzed, structured, mapped and classified. It should be noted, that, as described in greater detail below, the particular search performed at step 74 may be specified or crafted by the user. That is, interfaces for particular searches, both of at large sources and sources within an IKB, may be defined by a user via an appropriate search interface. In a present implementation, a search interface may be essentially identical to the resulting domain definition interface, including similar axes and labels, which may be selected by the user for performing the search. At step 76 the results of the application of the domain definition and rules are stored. At step 78 interface pages presenting the analysis and classification, and indeed the data entities themselves, are presented. Based upon such presentations, the domain definition and the attributes, as well as the rules and algorithms applied based upon the domain definition, may be altered as indicated by the arrows returning to the earlier processing steps illustrated in FIG. 2.

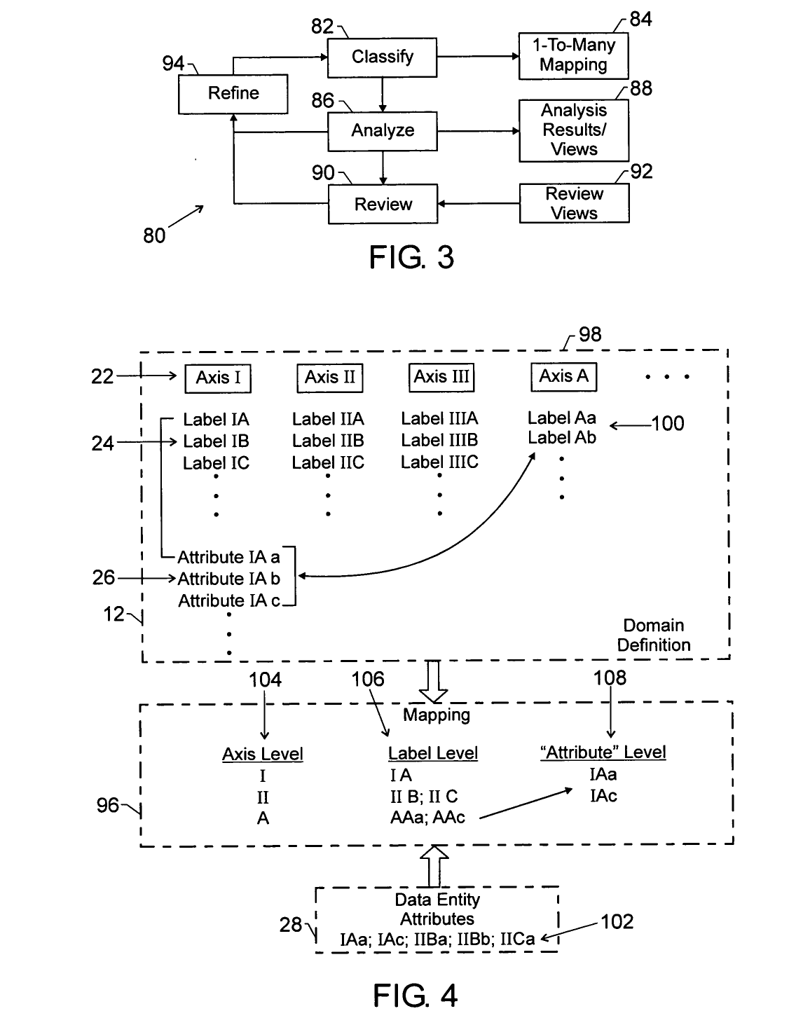

The particular steps and stages in accessing and treating data entities are represented diagrammatically in FIG. 3. In FIG. 3, the entity processing logic, designated generally by reference numeral 80, begins with classification of the data entities based upon the domain definition (or the search criteria defined by the user) and the rules and algorithms associated with the definition. This classification results in a one-to-many mapping and classification as indicated at reference numeral 84. As will be appreciated by those skilled in the art, such mapping is not typically performed by conventional search engines and data mining tools. That is, because many different axes, labels, and indeed various levels of these may be included in a domain definition, along with associated attributes, rules and algorithms, each data entity may be mapped onto and classified in more than one axis and label. Thus, any one data entity may be mapped onto many different conceptual subdivisions of the conceptual framework of the domain definition. This one-to-many mapping and classification provide a powerful basis for subsequent analysis, comparison, and consideration of the data entity.

Following the mapping and classification, analysis of the data entities may be performed as indicated at block 86 in FIG. 3. Again, such analysis may be based upon user-defined or axis rules and algorithms, as well as based upon statistical analytical techniques. For example, where documents are searched and classified, correspondences, overlaps, and distinctions between the documents may be analyzed. Moreover, simple analyses such as counts and relevancy of the documents may be determined based upon the multiple criteria and many-to-one mapping performed in the classification steps. The analysis results and views are then output as indicated at block 88. Such views may be part of a software package implementing the present techniques, or may be user-defined.

At step 90, the analysis results and views are reviewed by a user. The review may take any suitable form, and may be immediate, such as following a search or may take place at any subsequent time. Again, the reviews are performed on the individual analysis views as indicated at block 92. Based upon the review, the user may refine any portion of the conceptual framework as indicated at block 94. Such refinement may include alteration of the domain definition, any portion of the domain definition, change of the rules or algorithms applied, change of the type and nature of the analysis performed, and so forth. The present technique thus provides a highly flexible and interactive tool for identifying, analyzing and classifying the data entities.

As noted above, within the conceptual framework of the domain definition, many strategies may be envisaged for subdividing and defining the axes and labels. FIG. 4 illustrates an exemplary mapping process for developing the one-to-many mapping and classification of a data entity. For the present purposes, the mapping, designated generally by reference numeral 96, is performed based upon an exemplary domain definition 98. The domain definition includes a series of axes 22 and their associated label 24. FIG. 4 also illustrates one example of how a “conceptual zoom” may be provided through the domain definition itself. In the illustrated example, attributes 26 of a first axis I, and of a label IA within that axis are provided at a label level 100 of a subsequent axis A. That is, axis A is identical to label IA of axis I. Because the attributes of label IA are the same as the labels of axis A, if selected by the user in a search, as described below, the returned search results may represent not only that certain data entities corresponded to the criteria of label IA, but will provide a higher level or resolution or granularity for why the entities were selected, mapped and classified by reference to the labels of axis A.

As indicated at reference numeral 102 in FIG. 4, a particular data entity is assumed to include a series of attributes. In the case of a textual entity, these attributes may be words or phrases. That is, certain words or phrases defined by the attributes of the domain definition are found in the data entity. The mapping, then, represented by reference numeral 96, will indicate that the data entity is to be classified in accordance with the individual axes, labels and label attributes, corresponding to the attributes found in the entity. In this case, at an axis level 104, the entity will be classified in accordance with axes I, II and A. Further, at a label level, the entity will be classified in labels IA, IIB, IIC, AAa, and AAc. Still further, due to the conceptual zoom provided by the additional axis A, at an “attribute” level, the entity will be associated with attributes IAa and IAc. In a present implementation, the attributes are not directly displayed in the returned search results, as described below. However, by placing the attributes of label IA in the label level 100 of axis A, this additional classification will be performed.

The mapping illustrated in FIG. 4 is performed at the classification phase of the present techniques discussed above. It should be noted that this classification may be user-selected. That is, as described below, once the definition is established, all entities identified may be structured, mapped and classified in accordance with all axes, labels and attributes. However, where appropriate, a user may select only some of the axes and labels for the desired classification. Once the classification is performed, however, searches may be made to identify particular data entities corresponding to some or all of the axes, labels and attributes that make up the conceptual framework of the domain definition. For this reason, it may be advantageous to employ all axes, levels and attributes for the identification, structuring, mapping and classification of data entities, and to permit user selection of a subset of these in later searches. Where indexing or other data processing techniques are employed, moreover, the use of all axes and labels, and the associated attributes, permits the indexing to cover all of these, thereby greatly facilitating subsequent searching and analysis.

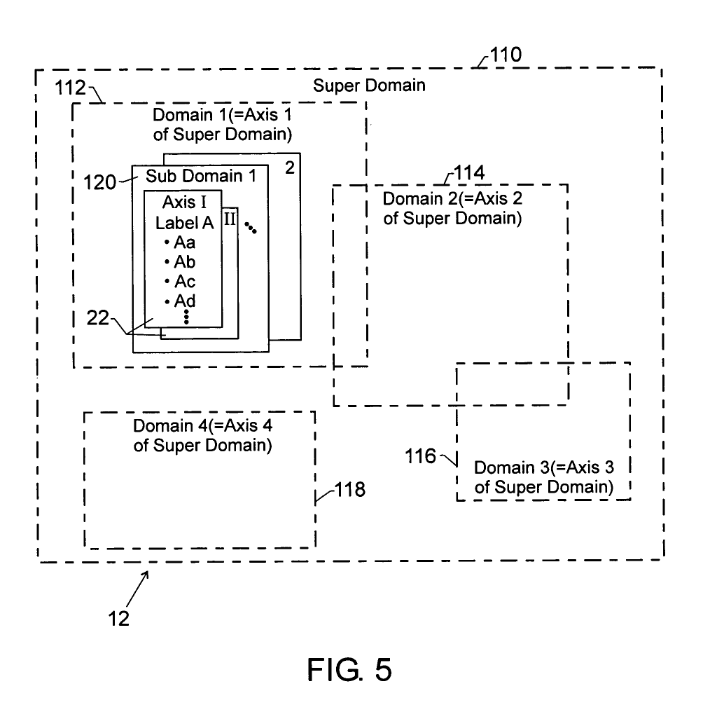

As mentioned above, the conceptual framework represented by the domain definition may include a wide range of levels, and any conceptual subdivision of the levels. FIG. 5 represents an exemplary domain 110, in this case termed a “super domain.” The term super domain is employed here to illustrate that the domain itself may be subdivided. That is, many different levels may be provided in the conceptual breakdown in classification. In the illustrated embodiment, four domains are identified in the super domain, including domains 112, 114, 116 and 118. These domains may overlap with one another. That is, certain labels or attributes within the domains may also be found in other domains. In certain cases, however, there may be no overlap between the domains. As indicated in FIG. 5, the domains themselves may be considered as axes of the super domain. At a further conceptual level, each domain may be then subdivided into sub-domains as indicated by sub-domains 120 for domain 112. That is, each domain may conceptually be subdivided so as to classify data entities distinctly within the domain. Ultimately, individual axes are defined, with labels for each axis, and attributes for each label.

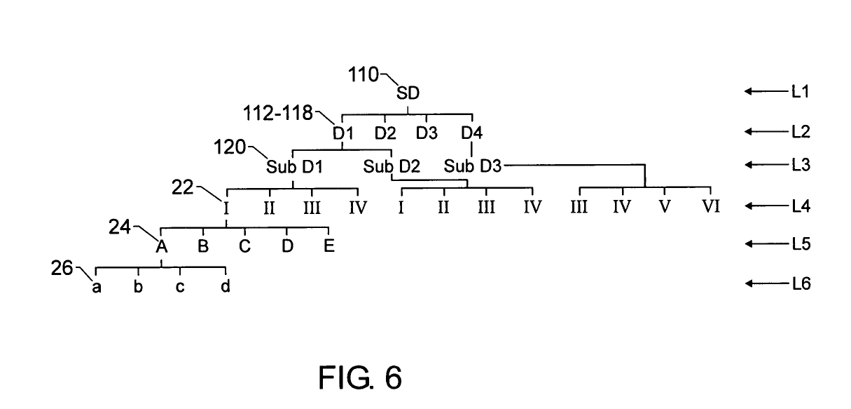

This multi-level approach to the conceptual framework defined by the domain is further illustrated in FIG. 6. FIG. 6 illustrates, in fact, six separate levels of classification and analysis. At a first level L1, the super domain is defined. This super domain 110 is typically the field itself in which the data entities are found. As will be appreciated by those skilled in the art, the field is, in fact, merely a level of abstraction defined by the user. Within the super domain may be found a series of domains 112-118, as indicated at level L2 in FIG. 6. Still further, a level of sub-domains may be identified within each domain, followed by a series of axes, with each axes having individual labels and ultimately attributes of each label, as represented by levels L3-L6. Thus, any number of conceptual levels may be defined for definition of the domain. Based upon the ultimate attributes of the data entities, then, mapping to and classification in corresponding levels and sublevels is accomplished.

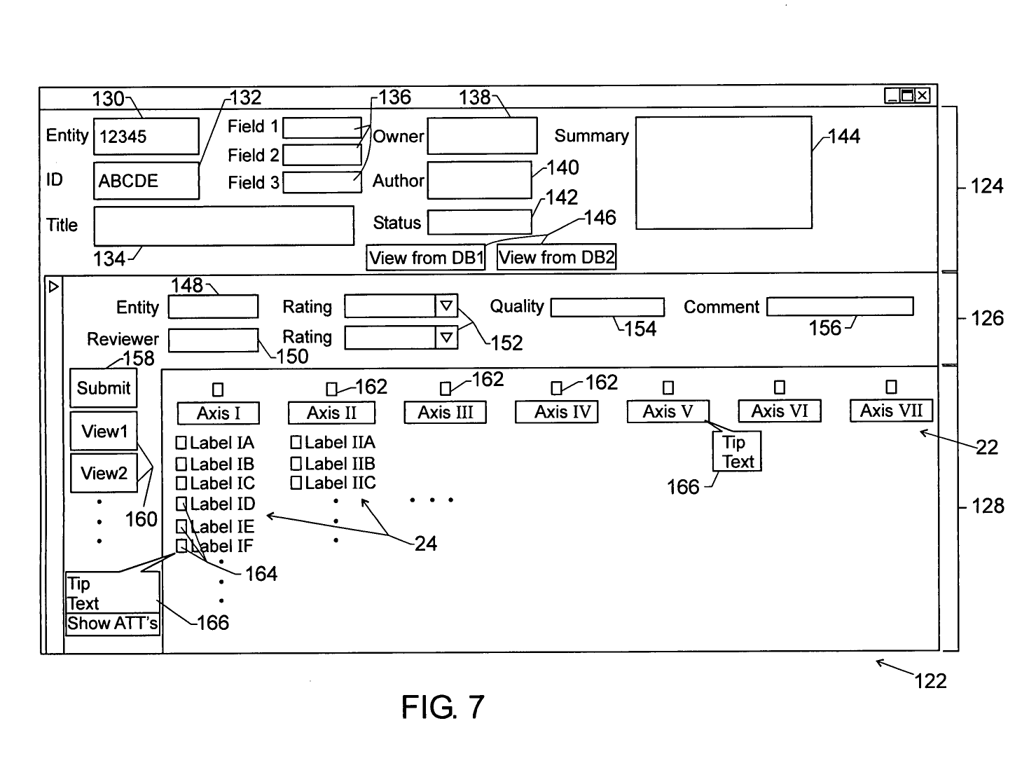

As mentioned above, the present techniques provide for user definition of the domain and its conceptual framework. FIG. 7 illustrates and exemplary computer interface page for defining a domain. By way of example only, in this illustrated implementation the domain includes only the domain level, the axis level, the label level, and associated attributes. The domain definition template indicated by reference numeral 22, may include a bibliographic data section 124, a subjective data section 126, and a classification data section 128, in which the axes and labels are listed.

Where provided, the bibliographic data section 124 enables certain identifying features of data entities to be provided in corresponding fields. For example, an entity field 130 may be provided along with a data entity identification field 132 uniquely identifying, together, the data entity. A title field 134 may also be provided for further identifying the data entity. Additional fields 136 may be provided, that may be user-defined. Data representative of the source or origin of the data entity may also be provided as indicated at blocks 138 and 140. Further information, such as a status field 142 may be provided where desired. Finally, a general summary field 144 may be provided, such as for receiving information such as an abstract of a document, and so forth. Selections 146 or field identifiers may be provided, such as for selecting databases from which data entities are to be searched, analyzed, mapped and classified. As will be appreciated by those skilled in the art, the exemplary fields of the bibliographical section 124 are intended here as examples only. Some or all of this information may be available from structured data entities, or the fields may be completed by a user. Moreover, certain of the fields may be filled only upon processing and analysis of the data entities themselves, or a portion of the entities. For example, such bibliographic information may be found in certain sections of documents, such as front pages of patent documents, bibliographic listings of books and articles, and so forth. Other bibliographic data may be found, for example, in headers of image files, text portions associated with audio files, annotations included in text, image and audio files, and so forth.

The subjective data section 126 may include any of a range of subjective data that is typically input by one or more users. In the illustrated example, the subjective data includes an entity identifying or designating field 148 and a field for identifying a reviewer 150. Subjective rating fields 152 may also be provided. In the illustrated embodiment, a further field 154 may be provided for identifying some quality of a data entity as judged by a reviewer, expert, or other qualified person. The quality may include, for example, a user-input relevancy or other qualifying indication. Finally, a comment field 156 may be included for receiving reviewer comments. It should be noted that, while some or all of the fields in a subjective data section 126 may be completed by human users and experts, some or all of these fields may be completed by automated techniques, including computer algorithms.

The classification data section 128 includes, in the illustrated embodiment, inputs for the various axes and labels, as well as virtual interface tools (e.g., buttons) for launching searches and performing tasks. In the illustrated embodiment, these include a virtual button 158 for submitting a domain definition for searching, analyzing, structuring, mapping and classifying data entities in accordance with the definition. Selection of views for presenting various results or additional interface pages may be provided as represented by buttons 160. A series of selectable blocks 162 are provided in the implementation illustrated in FIG. 7, that permit a user to select one or all of the axes making up the domain definition. Similarly, the user-selectable block 164 provided for each label. Although not illustrated in FIG. 7 in the interest of clarity, all of the axes may include, and typically will include, many different labels. Any number of axes may be provided in the domain definition, and any number of labels may be provided for each axes. Finally, a series of identifiers or tip boxes 166 may be provided that can be automatically viewed or viewable by a user (e.g., by selection of a button on a mouse or other interface device) to facilitate recalling the meaning or scope of individual axes or labels, or for showing attributes of individual labels.

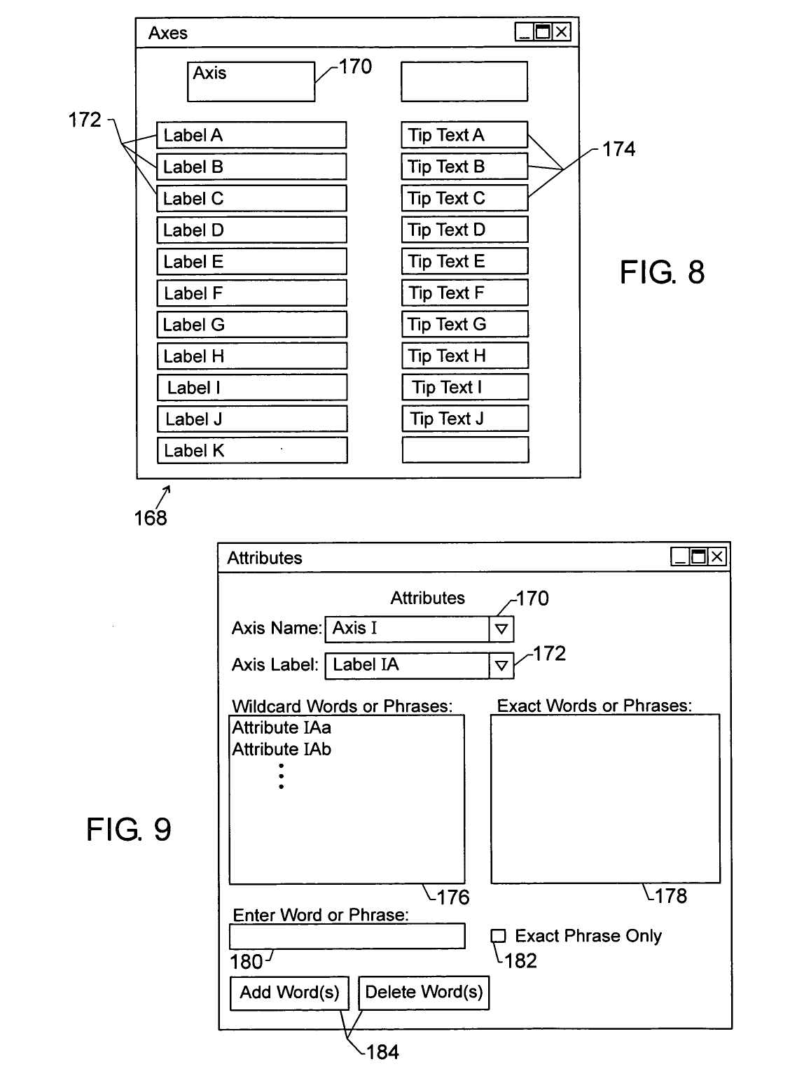

A range of additional interfaces may be provided for identifying and designating the axes and labels. For example, FIG. 8 represents an exemplary interface 168 for defining axes, labels and tip text for each label. In the interface, user may input the axes name in a field 170, and series of label names in field 172 for the axis. The interface 168 further permits the user to input tip text, as indicated at reference numeral 174, which may be used or displayed for the user to remind the user of the meaning of each label or the scope of their label. Similar tip text may, of course, be included for each axis.

Similarly, interface pages may permit the user to define the particular attributes of each label. FIG. 9 represents an exemplary interface page for this purpose. The page displays for the user the individual axis and the label for the axis for which the attributes are to be designated. In the illustrated example, the attributes are attributes of text documents, such that words and phrases may be defined by the user in a listing, such as in a field 176. A further field 178 is provided for exact word or phrases. Depending upon the design of the interface, input blocks, such as block 180 can be provided that permit the user to input the particular word or phrase, with selections, such as selection 182 for selecting whether it is to be a wildcard word or phrase or an exact word or phrase. A wide range of other attribute input interfaces may be envisaged, particularly for different types of data entities and different types of data expected to be encountered in the entity. Finally, blocks can be provided, along with other virtual tools, for adding attributes, deleting attributes, modifying attributes and so forth, as indicated generally at reference numeral 184 in FIG. 9.

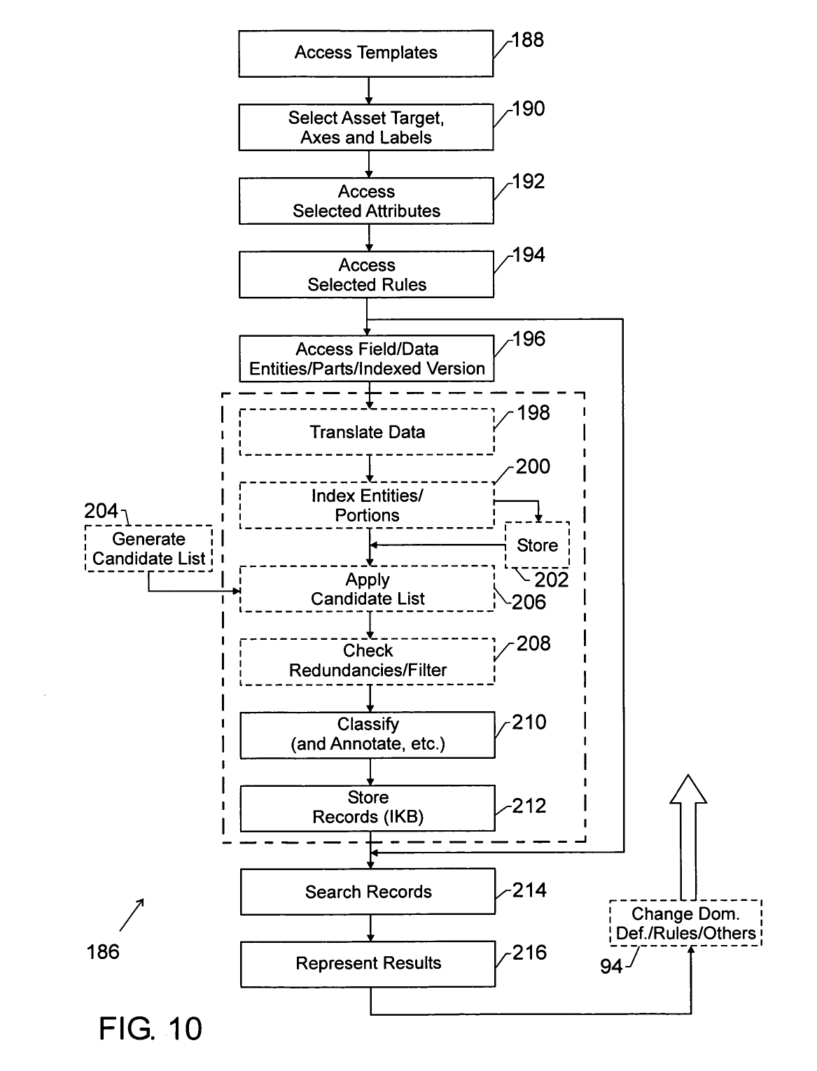

As noted above, the present techniques may be employed for identifying, analyzing, structuring, mapping, classifying and further comparing and performing other analysis functions on a variety of data entities. Moreover, these may be selected from a wide range of resources, including at large sources. Furthermore, the data entities may be processed and stored in an IKB as described above. FIG. 10 represents exemplary logic in performing certain of these operations.

The exemplary logic 186 illustrated in FIG. 10 begins with accessing one or more templates for selection, analysis and classification of the data entities, as indicated at reference numeral 188. In a present implementation, for initial selection and classification of data entities, all axes, labels and attributes of the domain definition are employed in this step. However, as indicated at reference numeral 190, where desired, the user may select a target database or resource for identification and classification of the data entities, along with axes and labels from the template. In the present context, the assets mentioned in step 190 are the data entities, and the asset target is one or more locations in which the entities are found or believed to be located. The asset target may, for example, include known databases, public access databases and libraries, subscription-based databases and libraries, and so forth. By way of example, when searching for intellectual property rights, such asset targets may include databases of a patent office. When searching for medical diagnostic images, as another example, the asset target may include repositories of such images, such as picture archiving and communication systems (PACS) or other repositories. Again, any suitable resource may be employed for this purpose.

Based upon the axes and labels selected at step 190, the selected attributes are accessed at step 192. These attributes would generally correspond to the axes and labels selected, as defined by the user and the domain definition. Again, for initial classification of data entities, such as for inclusion in an IKB, all axes and labels, and their associated attributes may be used. In subsequent searches, however, and where desired in initial searches, only selected attributes may be employed where a subset of the axes and/or labels are used as a search criterion. At step 194 the selected rules and algorithms are accessed. Again, these rules and algorithms may come into play for all analysis and classification, or only for a subset, such as depending upon the search criteria selected by the user via a search template. Finally, at step 196, access is made to the asset target field, to the data entity themselves, or parts of the data entities or even to indexed versions of the entities. This access will typically be by means of a network, such as a wide area network, and particularly through the Internet. By way of example, at step 196 raw data from the entities may be accessed, or only specific portions of the entities may be accessed, where such apportionment is available (e.g., from structure present in the entities). Thus, for intellectual property rights documents, such as patents, the access may be limited to specific subdivisions, such as front pages, abstracts, claims, and so forth. Similarly, for image files, access may be made to bibliographic information only, to image content only, or a combination of these.

Where the data entities are to be classified in an IKB for later access, reclassification, analysis, and so forth, a series of substeps may be performed as outlined by the dashed lines in FIG. 10. In general, these may include steps such as for translation of data as indicated at reference numeral 198. As will be appreciated by those skilled in the art, because the present tools may be implemented for a wide range of data, the format, content, and a structure of which may not be known, translation of the data may be in order at step 198. Such translation may include reformatting, sectioning, partitioning, and otherwise manipulating the data into a desired format for analysis and classification. Where desired, the entities may be indexed at step 200. Such indexing, as again will be appreciated by those skilled in the art, generally includes subdividing the data entities into a series of sections or portions, with each portion being tagged or indexed for later analysis. Such indexing may be performed on only portions of the entities, where desired. The indexing, where performed, is stored in step 202 to permit much more rapid accessing and evaluation of the indexed data entities for future searches.

A “candidate list” may be employed, where desired, to enhance the speed and facilitate classification of the particular data entities, particularly of textual documents. Where such candidate lists are employed, a candidate list is typically generated before hand as indicated at step 204 in FIG. 10. The candidate list may generally include the axes and labels, along with associated attributes that are particularly of interest in the targeted data entities. The candidate list may be used to quickly select data entities for inclusion in the IKB when certain simple criteria, such as the presence of a word or phrase, is found in the entity. Where such candidate lists are employed, the predefined list is applied in a step 206 to the accessed data entities. Further filtering and checks may be performed in a variety of ways, depending upon the nature of the data entity and the useful filtration that may be implemented. For example, in step 208 illustrated in FIG. 10, the process may call for checking for redundancies and filtering certain documents and other data entities. By way of example, where an IKB has already been established, step 208 may include verification of whether certain records or data entities are already included in the IKB, and elimination of such data entities for preclude redundant records in the IKB. Similarly, where records are found to essentially represent the same underlying information, these may be filtered in step 208. In the example of intellectual property rights, for example, it may be found that a particular patent application has issued as a patent and the patent information as opposed to the application information may be retained and the earlier information rejected at step 208, where desired. A wide variety of checks and verifications may be implemented.

At step 210 the data entities are mapped and classified. The mapping and classification, again, generally follows the domain definition by axis, label and attribute. As noted above, the classification performed at step 210 is a one-to-many classification, wherein any single data entity may be classified in more than one corresponding axis and label. Step 210 may include other functions, such as the addition of subjective information, annotations, and so forth. Of course, this type of annotation and addition of subjective review or other subjective input may be performed at a later stage. At step 210 the data entities, along with the indexing, classification, and so forth is stored in the IKB. It should be appreciated that, while the term “IKB” is used in the present context, this knowledge base may, in fact, take a wide range of forms. The particular form of the IKB may follow the dictates of particular software or platforms in which the IKB is defined. The present techniques are not intended to be limited to any particular software or form for the IKB.

It should be noted that the IKB will generally include classification information, but may include all or part of the data entities themselves, or processed (e.g., indexed or structured) versions of the entities or entity portions. The classification may take any suitable form, and may be a simple as a tabulated association of the structural system of the domain definition with corresponding data entities or portions of the entities.

Following establishment of the IKB, or classification of the data entities in general, various searches may be performed as indicated at steps 214. The arrow leading from step 194 to step 214 in FIG. 10 is intended to illustrate that the searches performed at step 214 may be performed either on data entities stored in an IKB or on data entities that are not stored in an IKB. That is, searches may be performed on at large sources of data entities, including external databases, structured data, unstructured data, and so forth. Where an IKB has been established, however, the accessing step performed at reference numeral 196 leads directly to accessing the IKB and searching the records of the IKB at step 214. At step 216, then, based upon the search defined at step 214, and the associated rules and algorithms, search results are presented. Again, these search results may be presented in a wide range of forms, both including analysis of individual data entities, or the search results may include the data entities themselves in their original form or in some highlighted or otherwise manipulated form.

Based upon any or all of the search results, the selection of data entities, the classification of data entities, or any other feature of the domain definition or its function, the domain definition, the rules, or other aspects of the conceptual framework and tools used to analyze it may be modified, as indicated generally at reference numeral 94 in FIG. 10. That is, if the search results are found to be over inclusive or under inclusive, for example, the domain definition may be altered, as may the rules used for selection of data entities, classification of the data entities or analysis of the entities. Similarly, if the analysis is found to provide an excess of distinctions or insufficient distinctions between the data entities, these may be altered at step 94. Moreover, as new conceptual distinctions are recognized, or new attributes are recognized, such as due to developments in a field, these may result in alternation of the domain definition, the rules and algorithms applied, and so forth. Still further, as new rules and algorithms for classification of the data entities are developed or become available, these may also result in changes at step 94. Based upon such changes, the entire process may be recast. That is, additional searches may be performed, additional data entities may be added to an IKB, new IKBs may be generated, and so forth. Indeed, such changes may simply result in reclassification of data entities already present in an IKB.

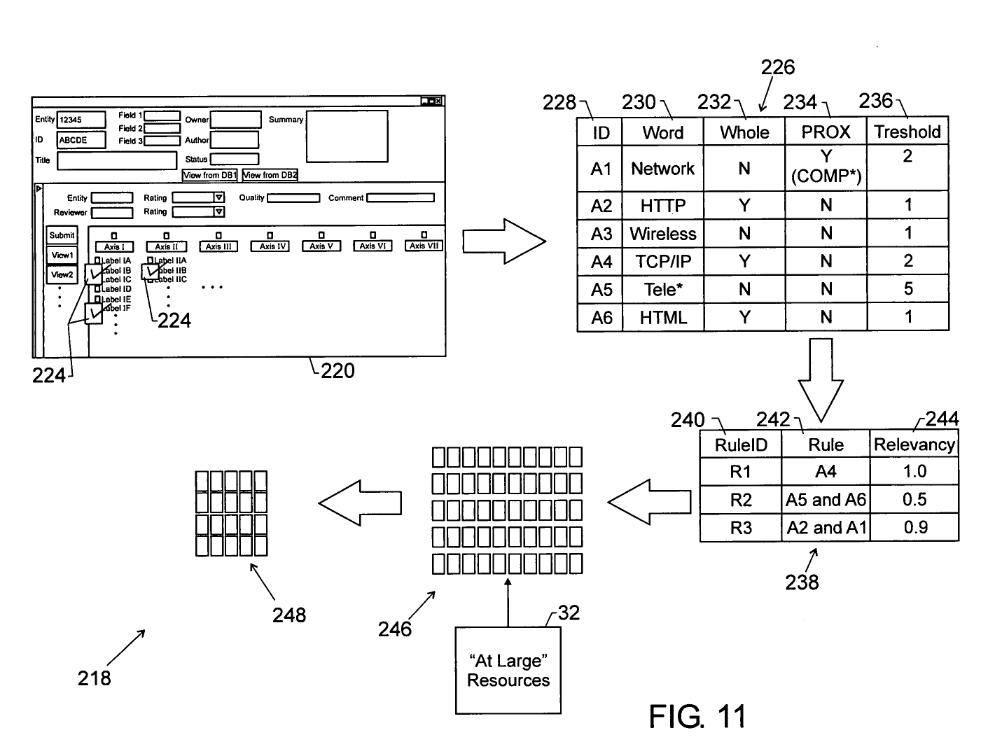

FIG. 11 represents, diagrammatically, the process set forth in FIG. 10 as applied to certain textual data entities for generating an IKB. The IKB generation process, designated generally be reference numeral 218 in FIG. 11, begins with a template 220, which may generally be similar to or identical to the template used to define the domain. As noted above, it may be preferable to initially cast the search for generation of the IKB to include all axes, labels and attributes of the labels. Where desired, however, the template may permit the user to select certain of the axes or labels, as indicated by the enlarged check boxes 224 in the template 220 of FIG. 11. Based upon the selection of some or all of the axes and labels, then, an association list 226 may be employed. The association list 226, in the illustrated example, may include identification of the individual attributes of particular labels, along with user-defined specific attributes and certain selection criteria. In the illustration of FIG. 11, for example, as one example, the particular attributes are words relating to web pages or a similar technical field. The selection criteria in the illustrated example include whether the entire word or less than the entire word is to be used in the identification of the data entities, whether a proximity rating is to be used, as indicated at reference numeral 34, and whether any particular threshold is to be used as indicated at reference numeral 236. As will be apparent to those skilled in the art, even within the field of textual searching and classification, many such selection criteria may be employed. The present techniques are not intended to be limited to any such selection criteria. Moreover, it should also be recognized that the selection criteria may be employed in the form of a quality of the attribute, or such criteria may also be implemented as a rule to be applied to the selection and classification process. Similarly, it should be noted that the attribute list may include various types of attributes, depending upon the types of data entities to be searched and classified. In general, “multi-media” attributes may be employed, such as for identifying and classifying images, waveforms, audio files, video files, and so forth, in addition to text files, and even complex combinations of these.

Based upon the domain definition, or a portion of the domain definition as selected by the user, and upon such inputs such as the candidate list, where used, rules are applied for the selection and classification of data entities as indicated by reference numeral 238 in FIG. 11. In the simple example illustrated, a rule identifier 240 is associated with various rules 242. Moreover, a relevancy criteria 244 may be implemented for each of the rules in the illustrated example. As noted above, it should be borne in mind that any desired rules may be used for the selection and classification of the data entities. In the case of text documents, these rules may be quite simple. However, for more complex documents, or where text and images, or text and other forms of data are to be analyzed for classification purposes, these rules may combine criteria for selection and analysis of text, as well as selection and analysis of other portions of the data, such as images. As also discussed above, the rules may be included in the code implementing the selection and classification process, or may be linked to the code. Where complex algorithms are employed, for example, for image analysis and classification, such algorithms may be too voluminous or may be used so sparingly as to make linking to the algorithms the most efficient and limitation.

Based upon the domain definition, any candidate lists, any rules, and so forth, then, at large resources 32 may be accessed, that include a large variety of possible data entities 246. The domain definition, its attributes, and the rules, then, permit selection of a subset of these entities for inclusion in the IKB, as indicated at reference numeral 248. In a present implementation, not only are these entities are selected for inclusion in the IKB, but additional data, such as indexing where performed, analysis, tagging, and so forth accompany the entities to permit and facilitate their further analysis, representation, selection, searching, and so forth.

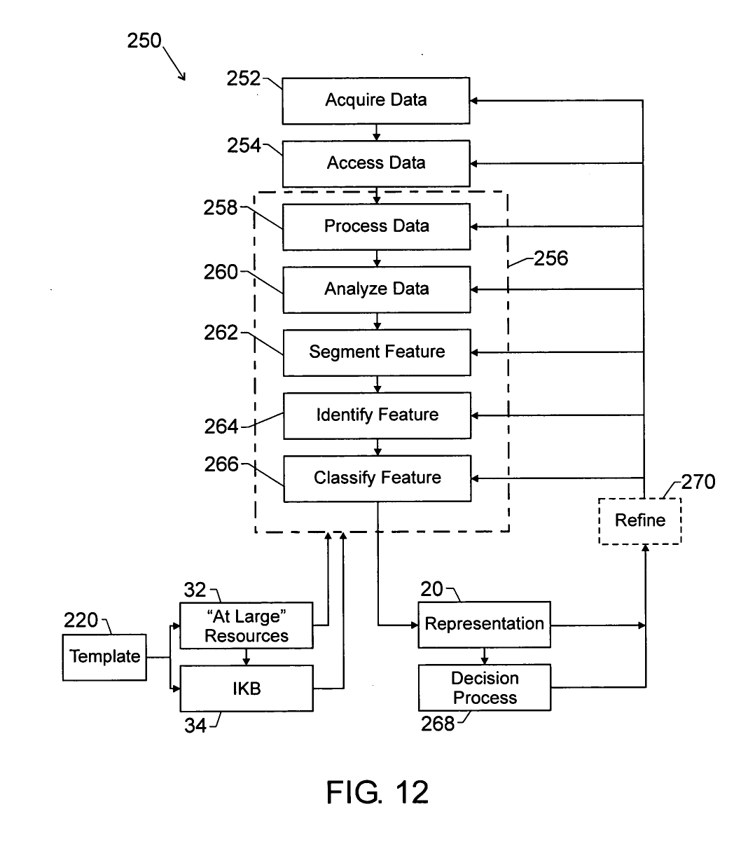

The analysis performed on the selected and classified data entities may vary widely, depending upon the interest of the user and upon the nature of the data entities. Moreover, even prior to the classification, during the classification, and subsequent to the initial classification, additional analysis and classification may be performed. FIG. 12 illustrates generally logic for computer-assisted processing, analysis and classification of features of interest in the data entities. This logic, designated generally by reference numeral 250 may be said to begin with the acquisition of the data contained in each entity. As noted above, the present process generally assumes that such acquisition is performed a priori. However, based upon certain analysis and classification, the present techniques may also recommend that additional data entities be created by acquiring additional data. At step 254, the data is accessed as described above. Subsequent processing via computer-assisted techniques follows access of the data, as indicated generally at reference numeral 256 in FIG. 12.

As noted above, the present technique provides for a high level of integration of operation in computer-assisted searching, analysis and classification of data entities. These operations are generally performed by computer-assisted data operating algorithms, particularly for analyzing and classifying data entities of various types. Certain such algorithms have been developed and are in relatively limited use in various fields, such as for computer-assisted detection or diagnosis of disease, computer-assisted processing or acquisition of data, and so forth. In the present technique, however, an advanced level of integration and interoperability is afforded by interactions between algorithms for analyzing and classifying newly located data entities, and for subsequent analysis and classification of known entities, such as in an IKB. The technique makes use of unprecedented combinations of algorithms for more complex or multimedia data, such as text and images, audio files, and so forth.

FIG. 12 provides an overview of interoperability of such algorithms, which may be referred to generally in the present context as computer-assisted data operating algorithms or CAX. Such CAX algorithms in the present context may be built upon algorithms presently in use, or may be modified or entirely constructed on the basis of the additional data sources and entities, integration of such data sources and entities, or for search analysis and classification of specific types of data entities. In the overview of FIG. 12, for example, an overall CAX system is illustrated as included a wide range of steps, processes or modules which may be included in a fully integrated system. As noted above, more limited implementations may also be envisaged in which some or a few only of such processes, functions or modules are present. Moreover, in presently contemplated embodiment, such CAX systems may be implemented in the context of an IKB such that information can be gleaned to permit adaptation or optimization of both the algorithms themselves and the data management by the data managed by the algorithms for analysis and classification of the data entity. Various aspects of the individual CAX algorithms may be altered, including rules or processes implemented in the algorithms, or specific rules may be written and called upon during the data entity mining, analysis and classification processes.

While many such computer-assisted data operating algorithms may be envisaged, certain such algorithms are illustrated in FIG. 12 for carrying out specific functions on data entities, with these processes being designated generally by reference numeral 256. Considering in further detail the data operating steps summarized in FIG. 12, at step 258 accessed data is generally processed, such as for indexing, redundancy checking, reformatting of data, translation of data, and so forth. As will be appreciated by those skilled in the art, the particular processing carried out in step 258 will depend upon the type of data entity being analyzed and the type of analysis or functions being performed. It should be noted, however, that data entities may be processed from any of the sources discussed above, including at large sources and IKBs. At step 258, similarly, analysis of the data entities is performed. Again, such analysis will depend upon the nature of the data entities, the data in the entities, and the nature of the algorithm on which the analysis is performed. Such processing may identify, for example, certain similarities or differences within or between entities. Such data may then be tabulated, counted, and so forth for presentation. Similarly, statistical analyses may also be performed on the data entities, to determine such relationships as relevancy, degree of similarity, or any other feature of interest both within the entities or between or among entities.

Following such processing and analysis, at step 260 features of interest may be segmented or circumscribed in a general manner. Recognition of features in textual data may include operations as simple as recognizing particular passages and terms, highlighting such passages and terms, identification of relevant portions of documents, and so forth. An image data, such feature segmentation may include identification of limits or outlines of features and objects, identification of contrast, brightness, or any number of image-based analyses. In a medical context, for example, segmentation may include delimiting or highlighting specific anatomies or pathologies. More generally, however, the segmentation carried out at step 260 is intended to simply discern the limits of any type of feature, including various relationships between data, extents of correlations, and so forth.

Following such segmentation, features may be identified in the data as summarized at step 262. While such feature identification may be accomplished on imaging data in accordance with generally known techniques, it should be borne in mind that the feature identification carried out at step 262 may be much broader in nature. That is, due to the wide range of data which may be integrated into the inventive system, the feature identification may include associations of data, such as text, images, audio data, or combinations of such data. In general, the feature identification may include any sort of recognition of correlations between the data that may be of interest for the processes carried out by the CAX algorithm.

At step 266 such features are classified. Such classification will typically include comparison of profiles in the segmented feature with known profiles for known conditions. The classification may generally result from attributes, parameter settings, values, and so forth which match profiles in a known population of data sets with a data set or entity under consideration. The profiles, in the present context, may correspond to the set of attributes for the axes and labels of the domain definition, or a subset of these where desired. Moreover, the classification may generally be based upon the desired rules and algorithms as discussed above. The algorithms, again, may be part of the same software code as the domain definition and search, analysis and classification software, or certain algorithms may be called upon as needed by appropriate links in the software. However, the classification may also be based upon non-parametric profile matching, such as through trend analysis for a particular data entity or entities over time, space, population, and so forth.

As indicated in FIG. 12, the processes carried out during the analysis and classification may be based upon either at large resources 32 or data entities stored in an IKB as indicated at reference numeral 34. As also noted in FIG. 12, these processes may be driven by input via a template 220 of the type described above. As a result of the analysis and classification, a representation is generally represented to the user as indicated at reference numeral 20.

The present techniques for searching, identification, analysis, classification and so forth of data entities is specifically intended to facilitate and enhance decision processes. The processes may include a vast range of decisions, such as marketing decisions, research and development decisions, technical development decisions, legal decisions, financial and investment decisions, clinical diagnostic and treatment decisions, and so forth. These decisions and their processes are summarized at reference numeral 268 in FIG. 12. As discussed above, based upon the representations 20, and additionally based the decision making processes, further refinements to the analysis and classification algorithms, the data entities, the domain definition, and so forth may be in order, as indicated at optional block 270 in FIG. 12. As will be appreciated by those skilled in the art, such refinement may include, but certainly not limited to, the acquisition of additional data, the acquisition of data under different conditions, particular additional analysis of data, further segmentation or different segmentation of the data, alternative identifications of features, and alternative classifications of the data.

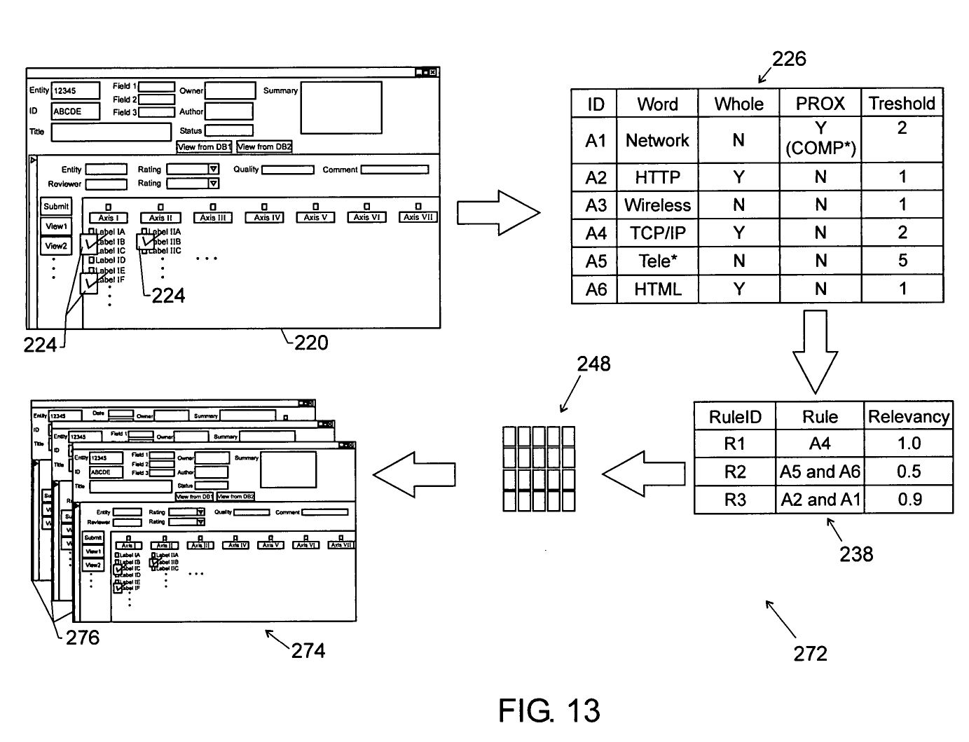

As noted above, additional interfaces are provided in the present technique for performing searches and further identification and classification of data entities, such as from an IKB. FIG. 15 illustrates an overview for performing searches of data entities, such as entities stored in an IKB. It would be noted that the overview is similar to that illustrated in FIG. 11 in which data entities are searched and structured for formation of the IKB. In the workflow illustrated in FIG. 13, designated generally by reference numeral 272, a search form 220 is again employed that includes a graphical illustration of the domain definition, including the axes and labels. Again, attributes and, where appropriate, association lists may be combined with the search template to define the features of the data entities which are to be searched and classified. An association list 226, may thus be used for automated search and classification. The user, then, may define the particular axes and labels which are to be located in the structured data entities comprising the IKB via the completed template 220. Based upon the completed template, the association list 226, and rules, designated generally by reference numeral 238, the IKB is searched. That is, selected and classified entities 248 are searched to identify and reclassify, where appropriate, the data entities that correspond to the criteria used for the search (as defined by the template, any association list, and the rules applicable). In the embodiment illustrated in FIG. 13, the search results are returned via a form that resembles the search template. However, in the representation, designated here as a “form view” 274, only the axes and labels located for each record or data entity are highlighted in the template. Thus, the user can quickly identify the bases for the one-to-many mapping performed in the classification procedure. A number of such records 276 may be returned, with each indicating, where desired, a bibliographic data, subjective data, classification data, and so forth as discussed above.

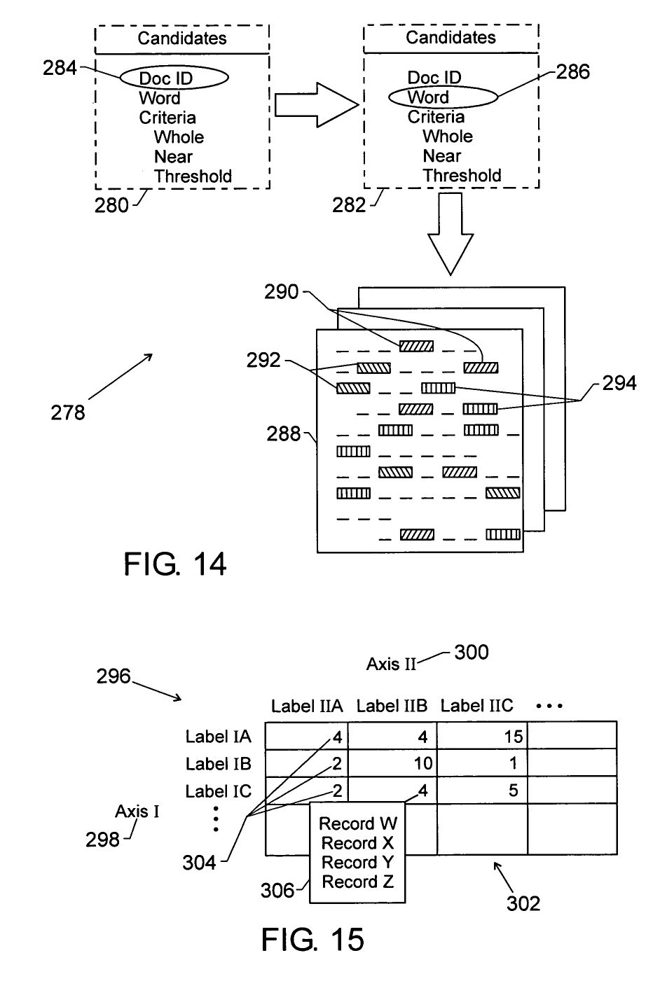

In another implementation, data entities may be highlighted for specific features or attributes located in the search and analysis steps, and classified into the structured data entity. FIG. 14 illustrates an exemplary workflow for one such implementation. The text highlighting implementation of FIG. 14, designated generally by reference numeral 278, may begin with identification of specific features of candidates from a candidate list 280. The candidate selections, indicated by reference numeral 282 are made from the list, and efficient searches may be carried out for highlighting individual features of interest. In the implementation illustrated in FIG. 14, for example, a text search is performed on a document ID field 284, with words being highlighted as indicated at reference numeral 286. Individual words, which may correspond to individual attributes of labels in the domain definition, will thus be highlighted as indicated in the entity record view 288 of FIG. 14. In a present implementation, the highlighting may be done by changing a word color or a background color surrounding a word. Different highlighting, as indicated by reference numerals 290, 292 and 294 are used for different terms, or, for example, for terms associated with a single label, or single axis. Here again, the basis for the classification (and selection) of the data entities can be readily apparent to the user by reference to the highlighting. As will be noted by those skilled in the art, while the relatively straightforward example of a text document as illustrated, similar techniques may be used on a wide range of data entity types. For example, as discussed below, image data, audio data, or other data, and combinations of these types of data may be analyzed and highlighted in similar manners. Where image data is highlighted, for example, graphical techniques may be employed, such as blocks surrounding features of interest, pointers indicating features of interest, annotations indicating features of interest and so forth. Where data entities including text, image, and other types data are analyzed, combinations of these highlighting approaches may be used.

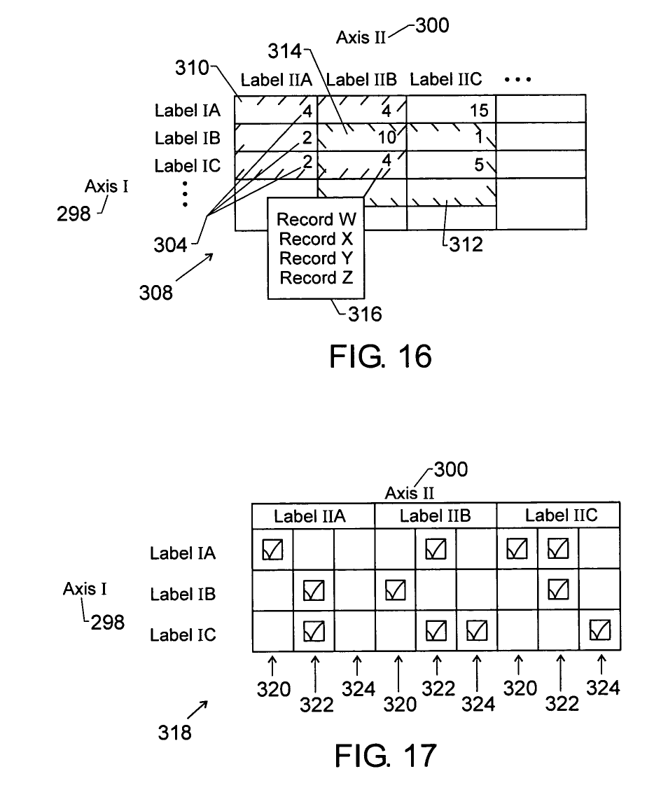

Further representations which may be used to evaluate the analyzed and classified data entities include various spatial displays, such as those illustrated in FIGS. 15-22. In the spatial display (or splay) illustrated in FIG. 16, a data-centric view of a series of records corresponding to search criteria and classified in accordance with the search criteria are viewed. The spatial display 296 takes the form of a matrix or array of data indicating a pair of axes 298 and 300 of the domain definition. The tabulated summary 302 follows these axes and the individual labels of each axis. A count or number of records or data entities corresponding to intersections of the axes and individual labels is indicated by a count or score number 304. Additional information may, of course, be displayed in each intersection block, as discussed in greater detail below. Where desired, additional information may be displayed, such as by clicking a mouse on a count to produce a drop-down menu or list, as indicated at reference numeral 306. It should be borne in mind that the illustrated example is one of many possibilities only. Additional possibilities are discussed below, and be formally a part of the myriad of options available to the system designer. In a present implementation, for example, additional links may be provided to the individual entities or records from the listing 306, with the records themselves available from the listing. Selection of records from the listing may result in display of a form view such as shown in FIG. 13 or a highlight view as indicated in FIG. 14, or any similar representation of all or part of the data entity.

A further example of a spatial display as illustrated in FIG. 16. The display illustrated in FIG. 16 may be considered a record-centric spatial display 308. The record-central display is similar to the display illustrated in FIG. 15, but highlights intersections of labels corresponding to attributes of individual data entities or records. That is, for example, a number of records returned for specific search criteria, such as a company owner of a particular intellectual property right, may be highlighted in a first color or graphic, as indicated by the right-slanted hatches in FIG. 16. Records corresponding to data entities returned for a second company may be indicated in a different manner, such as the left-slanted hatches. Of course, other graphical techniques, such as colors, where available, may be more indicative and apparent. Here again, the highlighting may indicate that at least one record in each of the intersection blocks was located for each of the highlighted features (e.g., a company owner). The spatial display thus make readily apparent where intersections exist between data entities returned having the attributes, and areas where no such records were returned. The specific record highlighting, indicated by reference numerals 310 and 312, may thus overlap, as in the case of the two central blocks in the intersection space 314, indicating that at least one record in each such block belongs to one or the other basis for the highlighting. Here again, additional graphical or analytical techniques may be employed, such as record listings 316, from which specific records or view may be accessed.

FIG. 17 represents an additional spatial display, which may be thought of as a different type of record-centric display. In the display of FIG. 17, axes 298 and 300 are again indicated, with corresponding labels for each axis. Blocks illustrating the intersections of each label are then provided. In the spatial display presentation 318, however, separate blocks for each individual record or data entity may be provided. Such blocks are indicated at reference numerals 320, 322 and 324. Based upon the content of the structured data entity, then, the individual intersection blocks may indicate whether a record contains the axis label attributes or not. For example, in the illustrated data, the data entities 320, 322 and 324 share no attributes corresponding to label IIA, but entities 322 and 324 share an intersection at label IC/IIB. Here again, the presentation of the data facilitates identification of the uniqueness or distinctiveness of data entities, and their similarities.

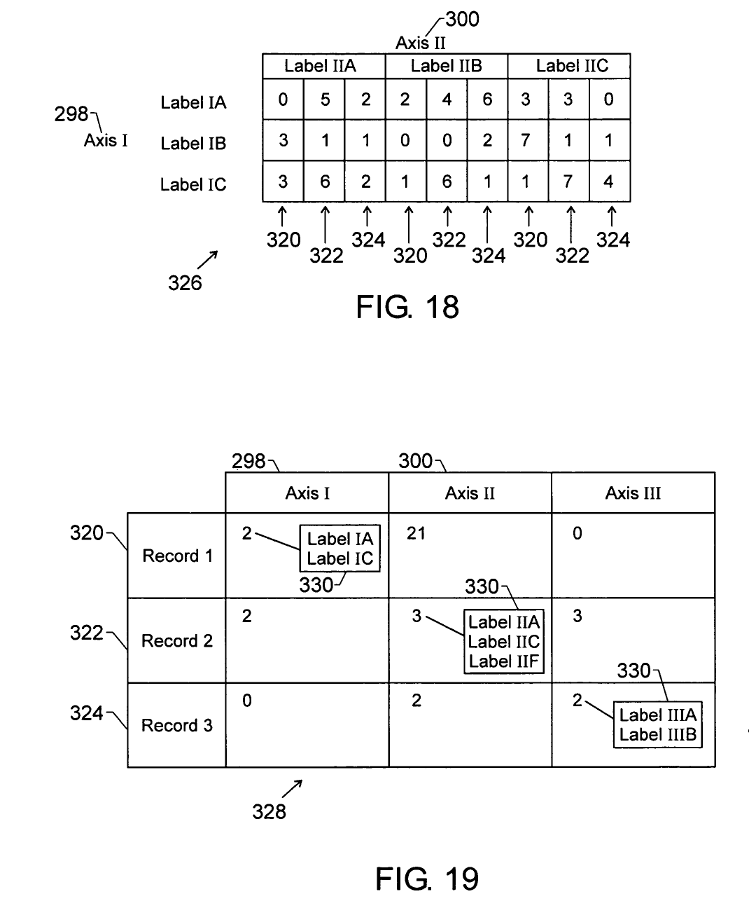

A somewhat similar spatial display is illustrated in FIG. 18. A spatial display of the type illustrated in FIG. 18 may be considered for specific features of interest, such as a company owner of a particular property right. Any other suitable feature, may, of course, be used for generating the display. As illustrated, axes and labels are again indicated in a tabulated form, but with the specific features of interest being called out in individual intersection blocks as indicated at reference numerals 320, 322 and 324. By way of example, in the case of company comparisons, each of the columns 320, 322 and 324 may correspond to the number of properties in each of the intersection blocks owned by each of the companies. Analysis is therefore apparent for the viewer, indicating strengths and weaknesses on a relative basis of each company owner. By way of example, in the illustrated example, company 322 would appear somewhat dominant in the intersection space IC/IIB, but weak, along company 320, in the intersection space IB/IIB.

A further illustrative example of a spatial display is shown in FIG. 19. FIG. 19 may be considered a different type of record or data entity-centric view. Here again, axes 298 and 300 are indicated. A number of data entities or records 320, 322 and 324 are also indicated in a tabulated form. Here, however, for the axes 298, 300 and any additional axes 330, individual labels for which classification was made based on the content of the data entities is illustrated, with all such correspondence as indicated. Thus, the user can readily discern how and why certain records were returned, how certain records were structured and classified, and the basis for the one-to-many mapping of each data entity record.

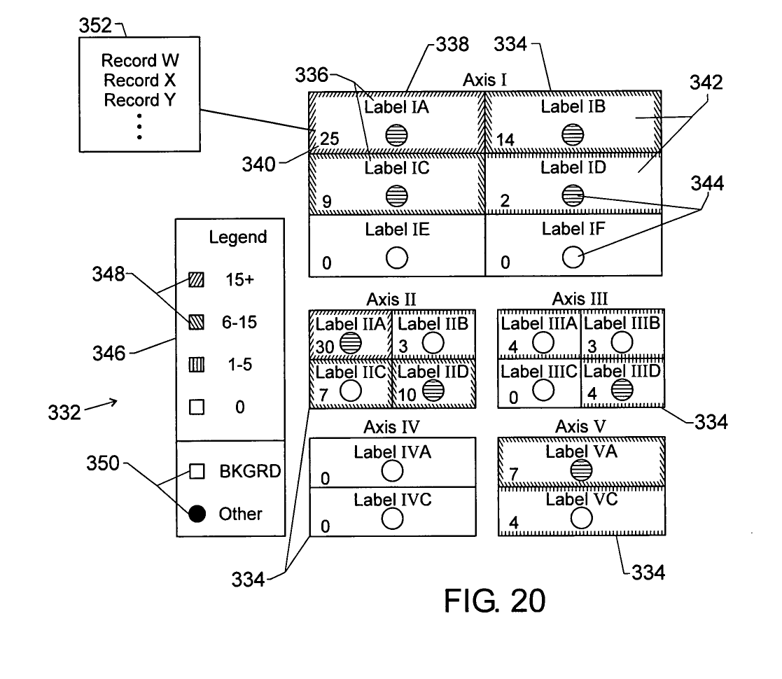

A further example of a spatial display is shown in FIG. 20. In the representation of FIG. 20, the spatial display 332 illustrates in a tiled-format graphical spaces corresponding to each axis 334 of the domain definition, with the individual labels 336 being called out for each axis. Each label is displayed in a block or area 338. In the illustrated example, a count or cumulative total 340 for the number of data entities corresponding to the attributes of each label is provided in the respective block. A background designated generally by reference numeral 342 may be colored or a particular graphic may be used for the background to indicate a level or number of data entities corresponding to the attributes of the individual labels. Moreover, in the illustrated example, an inset 344 is provided that may have a special meaning, such as data entities corresponding to a specific feature, such as a disease state, population of patients, institutions or care providers, and so forth. Here again, any other suitable meaning may be attributed to either the background or to the inset 344. Moreover, many such insets, or other graphical tools may be used for calling out the special features of interest.

A legend 346 is provided in the illustrated example for the particular color or graphic used to enhance the understanding of the presented data. In the illustrated example, for example, different colors may be used for the number of data entities corresponding to the attributes of specific labels, with the covers being called out in insets 348 of the legend. Additional legends may be provided, for example, as represented at reference numeral 350, for explaining the meaning of the backgrounds and the insets for each label. Thus, highly complex and sophisticated data presentation tools, incorporating various types of graphics, may be used for the analysis and decision making processes based upon the classification of the structured data entities. Where appropriate, as noted above, additional features, such as data entity record listings 352 may be provided to allow the user to “drill down” into data entities corresponding to specific axes, labels, attributes or any other feature of interest.

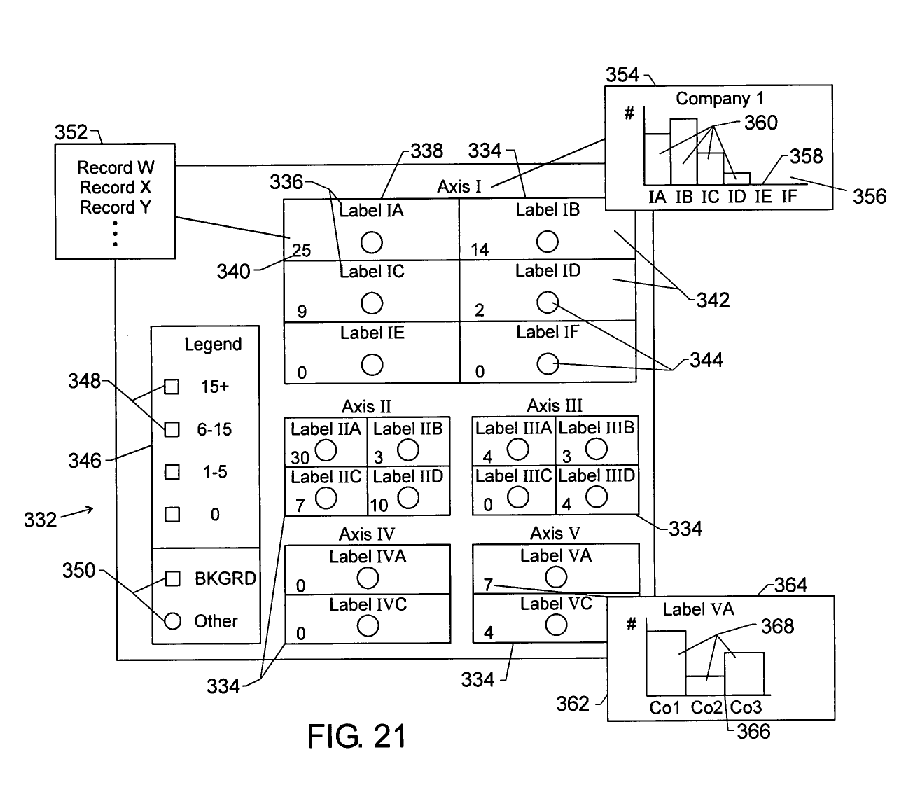

FIG. 21 illustrates the basic spatial display of FIG. 20, with additional illustrative graphics associated. In the illustration of FIG. 21, for example, graphical representations of a number of specific features may be shown, such as insets or menus, graphics, linked displays, and so forth, for classifying the individual data entities by counts, such as of care providers, institutions, or companies, or any other feature of interest. In the inset of 354, for example, a user may display the number of data entities in a graphical format 356 corresponding to individual labels of the first axis I. As illustrated, for example, a company of interest (“Company 1”) is illustrated to have a number of data entities corresponding to individual labels IA-IF, with counts of individual data entities or records being displayed in a graphical bar chart in which the number or account of data entities is indicated for each individual label shown along an axis 358. The counts may be represented by the bars 360 in this example. Similarly, as indicated by the graphical display 362 in FIG. 21, for an individual label, then, a number of data entities may be displayed for different companies (e.g., “Co 1,” “Co2,” “Co3”). The company designations may be indicated along an axis 366, then, with the counts being indicated by bars 368. The graphical representation 364 provides an indication, then of the number of features (e.g., patients with particular conditions, pieces of equipment, insurance claims, treatments provided, etc.) by each company for an individual label. Here again, any other feature may be provided for such analysis and display.

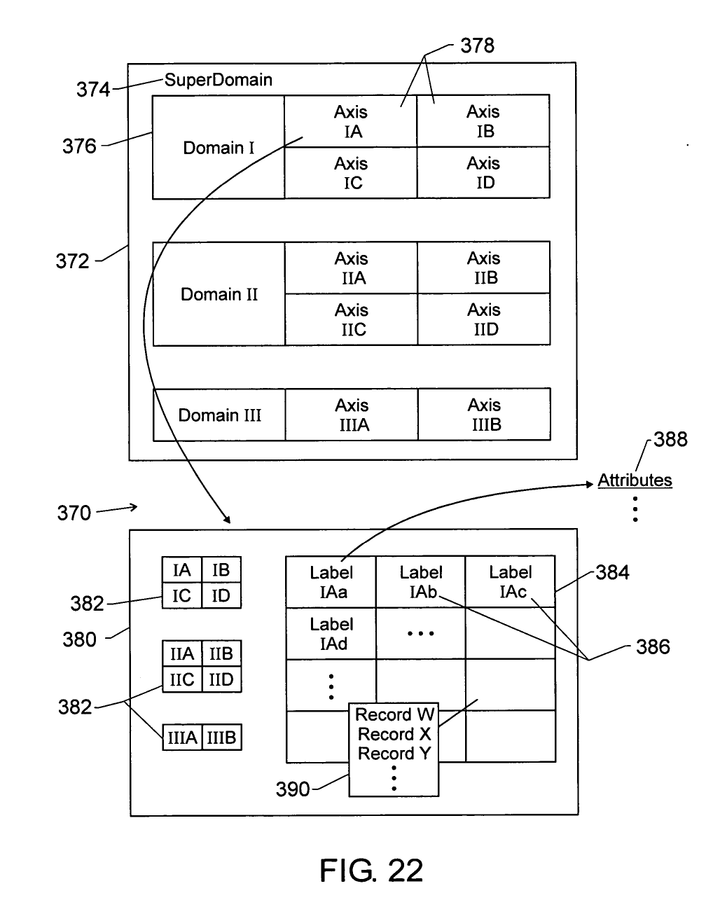

FIG. 22 shows an example of an interactive spatial display of representation of an analyzed and classified data entities, such as may be implemented through an interactive computer interface. The interactive representation 370 includes a top level view, of a superdomain 374 in the illustrated example. As noted above, such designations may be somewhat arbitrary, and indicate simply levels of classification as defined for the data entities. As shown in FIG. 22, the superdomain includes several individual domains 376, with each domain including a series of axes 378. As noted above, in the definition of the superdomain and of the domains, each axis will be associated with individual attributes or features of interest by which the structure data entities will be analyzed and classified. Upon being presented with the graphical illustration superdomain, then, a user may “drill down” into individual domains or axes as indicated by the view 380. In the illustrated implementation, by selecting axis IA, the view 380 is produced in which the individual labels of the selected axis are displayed in an expanded inset 384. The inset illustrates the labels as indicated at reference 386, and additional information, such as counts or cumulative numbers of data entities corresponding to the labels may be displayed (not shown in FIG. 22). Here again, each of the labels will be associated with attributes as indicated by reference numeral 388 in FIG. 22. The attributes may or may not be displayed along with the labels, but the attributes may be accessible to the user as an indication of the basis for which selection and classification of data entities was made. In the implementation of FIG. 22, again, the individual axes of the other domains may be collapsed as indicated at reference numeral 382. As noted with respect to the other spatial displays above, other graphics, such as record listings 390 may be provided to permit the user to view data entities, portions of data entities, summaries of data entities, and so forth. Other types of graphical representations may, of course, be provided, such as the charted, tabulated or highlighted views summarized above.

As mentioned throughout the foregoing discussion, the present techniques may be employed for searching, classifying and analyzing any suitable type of data entity. In general, several types of data entities are presently contemplated, including text entities, image entities, audio entities, and combinations of these. That is, for specific text-only entities, word selection and classification techniques, and techniques based upon words and text may be employed, along with text indicating by graphical information, subjective information, and so forth. For image entities, a wide range of image analysis techniques are available, including computer-assisted analysis techniques, computer-assisted feature recognition techniques, techniques for segmentation, classification, and so forth.

In specific domains, such as in medical diagnostic imaging, these techniques may also permit evaluation of image data to analyze and classify possible disease states, to diagnose diseases, to suggest treatments, to suggest further processing or acquisition of image data, to suggest acquisition of other image data, and so forth. The present techniques may be employed in images including combined text and image data, such as textual information present in appended bibliographic information. As will be apparent to those skilled in the art, in certain environments, such as in medical imaging, headers appended to the image data, such as standard DICOM headers may include substantial information regarding the source and type of image, dates, demographic information, and so forth. Any and all of this information may be analyzed and thus structured in accordance with the present techniques for classification and further analysis. Based upon such analysis and classification, the data entities may be stored in a knowledge base, such as an integrated knowledge base or IKB, in a structured, semi-structured or unstructured form. As will be apparent to those skilled in the art, the present technique thus allow for a myriad of advantageous uses, including the integrated analysis of complex data sets, for such purposes as financial analyses, recognitions of diseases, recognitions of treatments, recognitions of demographics of interest, recognitions of target markets, recognitions of risk, or any other correlations that may exist between data entities but are so complex or unapparent as to be difficult otherwise to recognize.

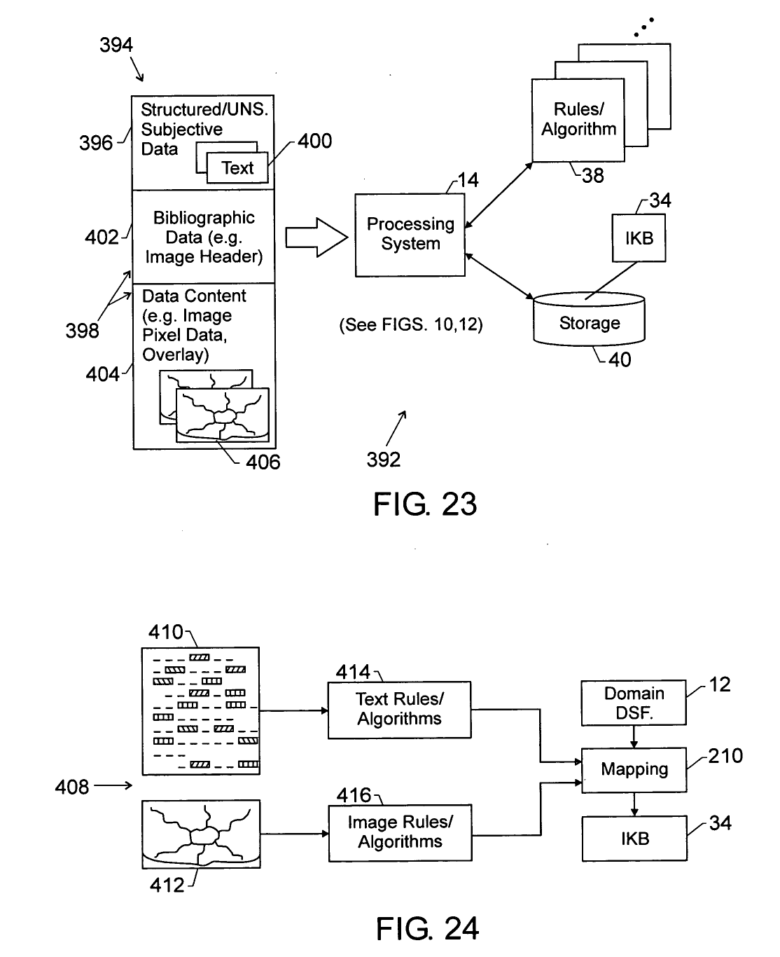

FIGS. 23, 24 and 25 illustrate application of the foregoing techniques to image data, and particularly to image data associated with text data. As shown in FIG. 23, the image/text entity processing system 392 generally follows the outlines of the techniques described above, but may begin with image and text files as indicated at reference numeral 394. Here again, the data entities corresponding to the files may be included in a single file or in multiple files, or links between files may be provided, such as for annotations based upon image data, and so forth. In general, each entity will include, then, a textual segment 396 and an image segment 398. The textual segment 396 may include structure, unstructured or subjective data in the form of one or more strings of text 400. The image segment 398 may include bibliographic data 402, such as text data in an image header, and image content data 404. Image content data will typically be in the form of image pixel data, voxel data, overlay data, and so forth. In general, the image data 404 may generally be sufficient to permit the reconstruction of visual images 406 or series or images for display in accordance with desired reconstruction techniques. As will be apparent to those skilled in the art, the particular reconstruction technique may generally be selected in accordance with the nature of the image data, the type of imaging system from which the data was acquired, and so forth.

The data entities are provided to a processing system 14 of the type described above. In general, all of the processing described above, particularly that described with respect to FIGS. 10 and 12, may be performed on the complex data entities. In accordance with these processing techniques, specific feature of interest, both in the text, in the images, and between the text and the images may be segmented, identified, filtered, processed, classified and so forth in accordance with the domain definition and the rules or algorithms defined by the domain definition as indicated at reference numeral 38. Based upon the processing performed on the complex data entities, then, resulting structured data may be stored in any suitable storage 40, and an integrated knowledge base or IKB may be generated as indicated at reference numeral 34. As also noted above, based upon the one-to-many mapping performed for each of the data entities, similar searches may be performed for individual features of interest in either the text, the images, or both. While FIG. 23 represents text and image files in the complex data entities, it should also be noted that the data entities may include text and audio data, audio data and image data, text and audio and image data, or even additional types of data, such as waveform data, or data of any other type.

The specific image/text entity processing 408 performed on complex data entities is generally illustrated in FIG. 24. As noted above, text data 410 (shown in FIG. 24 in a highlight view) and image data 412 is analyzed and classified in accordance with individual text rules an algorithms 414 and individual image rules and algorithms 416. It should be noted, however, that certain of the rules and algorithms for classification and mapping may include criteria based upon text and image data. For example, the user may have a particular interest in particular anatomical features of interest visible in image data but for a specific group of subjects as discernable only from the text analysis. Such combined analysis provides a powerful tool for enhanced classification and mapping. Based, then, upon the domain definition 12, the mapping is performed as indicated at block 210 in FIG. 24 to provide results which may be, then, stored in an IKB 34.

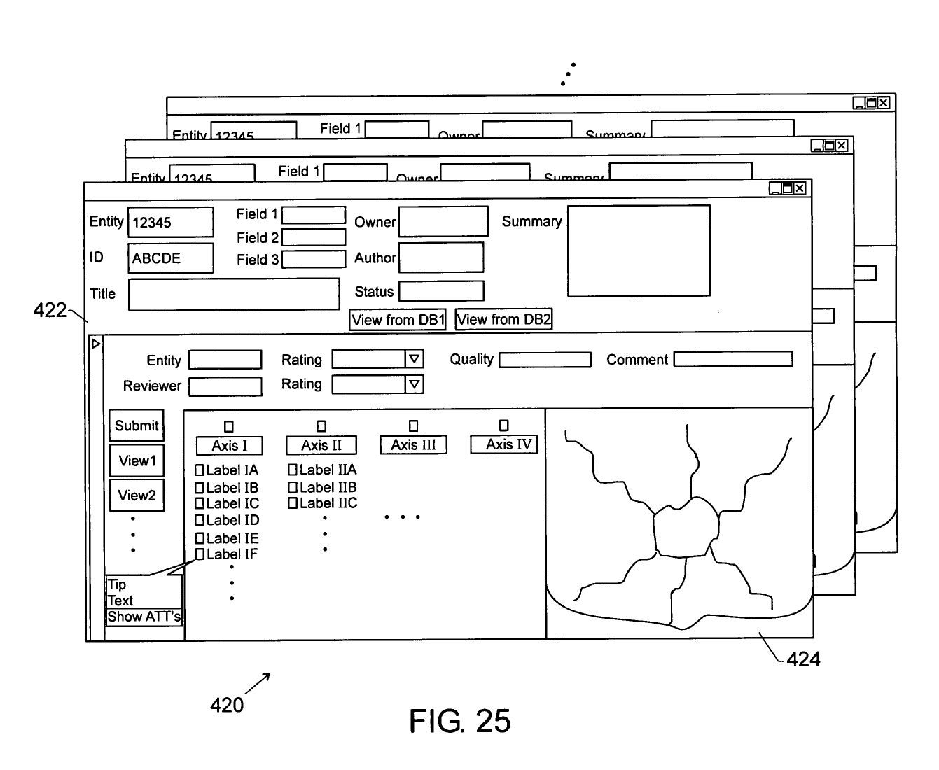

In addition to analysis and classification of complex data entities, all of the techniques described above may be used for complex data entities, including text, image, audio, and other types of data as indicated generally in FIG. 25. FIG. 25 shows an exemplary form view for combination text/image data similar to that described above for text data alone. In the summaries provided in views 420, shown in FIG. 25, bibliographic information may be provided along with subjective information and classification information, all designated generally by reference numeral 422. Here, however, additional information on analysis of the image data may be provided, along with image representations, such as indicated at reference numeral 424. Where appropriate, links to actual images, annotated images or additional subjective or bibliographic data may, of course, be provided.

The foregoing techniques may be used in a wide range of applications in the medical field. In one exemplary implementation, medical diagnostic image files may be classified. Such files typically include both image data and bibliographic data. Subjective data, annotations by physicians, and the like may also be included. In this example, a user may define a domain having axes corresponding to particular anatomies, particular disease states, treatments, demographic data, and any other relevant category of interest. Here again, the labels will subdivide the axes logically, and attributes will be designated for each label. For text data, the attributes may be terms, words, phrases, and so forth, as described in the previous example. However, for image data, a range of complex and powerful attributes may be defined, such as attributes identifiable only through algorithmic analysis of the image data. Certain of these attributes may be analyzed by computer aided diagnosis (CAD) and similar programs. As noted above, these may be embedded in the domain definitions, or may be called as needed when the image data is to be analyzed and classified.

It should be noted that in this type of implementation, text, image, audio, waveform, and other types of data may be analyzed independently, or complex combinations of classifications may be defined. Where entities are classified by the one-to-many mapping, then, rich analyses may be performed, such as to locate populations exhibiting particular characteristics or disease states discernable from the image data, and having certain similarities or contrasts in other ways only discernable from the text or other data, or from combinations of such data.

Depending upon the information of interest, the analysis and presentation techniques described above may be employed, and adapted to the particular type of entity. For example, a text document such as a patient record, laboratory results, physician annotation, medical article, and so forth may be displayed in a highlight view with certain pertinent words or phrases highlighted. Images too may be highlighted, such as by changes in color for certain features or regions of interest, or through the use of graphical tools such as pointers, boxes, and so forth.

Many other uses of the IKB generation and utilization techniques discussed above may also be made. Certain of these are described in U.S. patent application Ser. No. 10/323,086, entitled “Integrated Medical Knowledge Base Interface System and Method”, filed Dec. 18, 2002, by Sabol et al., which is herein incorporated by reference in its entirety.

Moreover, the data entities identified, classified and analyzed in accordance with the present techniques may originate from various types of resources, such as data resources and controllable and prescribable resources. The data resources may be designed to be accessed for identification of data entities as described above, which will typically be stored in databases or other data structures, as discussed below. The entities will then be available as a resource to clinicians. Controllable and prescribable resources may include various laboratory, imaging, clinical examination and other resources available for collecting information from patients or known populations which may then form data entities identified and classified by the techniques discussed above.

The data resources may include a range of information types. For example, many sources of information may be available within a hospital or institution. As will be appreciated by those skilled in the art, the information may be included within a radiology department information system, such as in scanners, control systems, or departmental management systems or servers. Similarly, such information may be stored in an institution within a hospital information system in a similar manner. Many such institutions further include data, particularly image data, archiving systems, commonly referred to as PACS in the form of compressed and uncompressed image data, data derived from such image data, data descriptive of system settings used to acquire images (such as in DICOM or other headers appended to image files), and so forth. In addition to data stored within institutions, data may be available from patient history databases as indicated at reference numeral 50. Such databases, again, may be stored in a central repository within an institution, but may also be available from remote sources to provide patient-specific historical data. Where appropriate, such patient history databases may group a range of resources searchable by the data processing system and located in various institutions or clinics.

Other data resources may include databases such as pathology databases. Such databases may be compiled both for patient-specific information, as well as for populations of patients or persons sharing medical, genetic, demographic, or other traits. Moreover, external databases may be accessed. Such external databases may be widely ranging in nature, such as databases of reference materials characterizing populations, medical events and states, treatments, diagnosis and prognosis characterizations, and so forth. Such external databases may be accessed by the data processing system on specific subscription bases, such as on ongoing subscription arrangements or pay-per-use arrangements. Similarly, genetic and similar databases 56 may be accessed. Such genetic databases may include gene sequences, specific genetic markers and polymorphisms, as well as associations of such genetic information with specific individuals or populations. Moreover, financial, insurance and similar databases may be accessible for data entities to be incorporated into the IKB or for analysis otherwise. Such databases may include information such as patient financial records, institution financial records, payment and invoicing records and arrangements, Medicaid or Medicare rules and records, and so forth.

Finally, other databases may be accessed by the data processing system. Such other databases may, again, be specific to institutions, imaging or other controllable or prescribable data acquisition systems, reference materials, and so forth. The other databases, as before, may be available free or even internal to an institution or family of institutions, but may also be accessed on a subscription bases. Such databases may also be patient-specific, or population-specific to assist in the analysis, processing and other functions carried out by the techniques described above. Furthermore, the other databases may include information which is clinical and non-clinical in nature. For assistance in management of financial and resource allocation, for example, such databases may include administrative, inventory, resource, physical plant, human resource, and other information which can be accessed and managed to improve patient care.

The various data resources from which the data entities are drawn may also communicate between and among themselves. Thus, certain of the databases or database resources may be equipped for the direct exchange of data, such as to complete or compliment data stored in the various databases.

In general, the controllable and prescribable resources may be patient-specific or patient-related, that is, collected from direct access either physically or remotely (e.g. via computer link) from a patient. The resource data may also be population-specific so as to permit analysis of specific patient risks and conditions based upon comparisons to known population characteristics. It should also be noted that the controllable and prescribable resources may generally be thought of as processes for generating data. Indeed, while may of the systems and resources described more fully below will themselves contain data, these resources are controllable and prescribable to the extent that they can be used to generate data as needed for appropriate treatment of the patient. Among the exemplary controllable and prescribable resources are electrical resources. Such resources, as described more fully below, may include a variety of data collection systems designed to detect physiological parameters of patients based upon sensed signals. Such electrical resources may include, for example, electroencephalography resources (EEG), electrocardiography resources (ECG), electromyography resources (EMG), electrical impedance tomography resources (EIT), nerve conduction test resources, electronystagmography resources (ENG), and combinations of such resources. Moreover, various imaging resources may be controlled and prescribed. A number of modalities of such resources are currently available, such as X-ray imaging systems, magnetic resonance (MR) imaging systems, computed tomography (CT) imaging systems, positron emission tomography (PET) systems, flouorography systems, mammography systems, sonography systems, infrared imaging systems, nuclear imaging systems, thermoacoustic systems, and so forth.

In addition to such electrical and highly automated systems, various controllable and prescribable resources of a clinical and laboratory nature may be accessible. Such resources may include blood, urine, saliva and other fluid analysis resources, including gastrointestinal, reproductive, and cerebrospinal fluid analysis system. Such resources may further include polymerase (PCR) chain reaction analysis systems, genetic marker analysis systems, radioimmunoassay systems, chromatography and similar chemical analysis systems, receptor assay systems and combinations of such systems. Histologic resources, somewhat similarly, may be included, such as tissue analysis systems, cytology and tissue typing systems and so forth. Other histologic resources may include immunocytochemistry and histopathological analysis systems. Similarly, electron and other microscopy systems, in situ hybridization systems, and so forth may constitute the exemplary histologic resources. Pharmacokinetic resources may include such systems as therapeutic drug monitoring systems, receptor characterization and measurement systems, and so forth.

In addition to the systems which directly or indirectly detect physiological conditions and parameters, the controllable and prescribable resources may include financial sources, such as insurance and payment resources, grant sources, and so forth which may be useful in providing the high quality patient care and accounting for such care on an ongoing basis. Miscellaneous other resources may include a wide range of data collection systems which may be fully or semi-automated to convert collected data into a useful digital form. Such resources may include physical examinations, medical history, psychiatric history, psychological history, behavioral pattern analysis, behavioral testing, demographic data, drug use data, food intake data, environmental factor information, gross pathology information, and various information from non-biologic models. Again, where such information is collected manually directly from a patient or through qualified clinicians and medical professionals, the data is digitized or otherwise entered into a useful digital form for storage and access for the mapping and classification described above.

As discussed above, certain of these resources may communicate directly between and among themselves. Thus, imaging systems may draw information from other imaging systems, electrical resources may interfaced with imaging systems for direct exchange of information (such as for timing or coordination of image data generation, and so forth).

As noted above, based upon the classification of the data entities in accordance with the conceptual framework of the domain definition, many types of further analysis and processing may be done, particularly in medical contexts. For example, various initiating sources may be considered for initiating the data acquisition, processing, and analysis on the data from the resources and the IKB described above. The initiating sources may commence processing in accordance with routines stored in one or more data processing system, IKBs, or furthermore within the resources, including the controllable prescribable resources and the data resources. The particular processing rules and algorithms may be stored, as noted above, and a single computer system comprised in the data processing system, or dispersed through various computer systems which cooperate with one another to perform the data processing and analysis. Following initiation of the processing, processing strings may be carried out. These processing strings may include a wide range of processing and analysis of functions, typically designed to provide a caregiver with enhanced insights into patient care, to process the data required for the patient care, including clinical and non-clinical data, to enhance function of an institution providing the care, to detect trends or relationships within the patient data, and to perform general discovery and mining of relationships for future use.

The present technique contemplates that a range of initiating sources may commence the processing and analysis functions in accordance with the routines executed by the system. In particular, such initiating sources may include a user initiating source, an event or patient initiating source, a data state change source, and a system or automatic initiating source. Where a user, such as a clinician, physician, insurance company, clinic or hospital employee, management or staff user, and the like initiates a request that draws upon the IKB or the various integrated resources described above, a processing string may begin that calls upon information either already stored within the IKB or accessible by locating, accessing, and processing data within one or more of the various resources. In a typical setting, a user may initiate such processing at a workstation where a query or other function is performed. As noted above, the query may be obvious to the user, or may be inherent in the function performed on a particular workstation.

Another contemplated initiating source is the event or patient. In general, many medical interactions will begin with specific symptoms or medical events which trigger contact with a medical institution or practitioner. Upon logging such an event by a patient or clinician interfacing with the patient, a processing string may begin which will include a range of interactive steps, such as access to patient records, updating of patient records, acquisition of details relating to symptoms, and so forth as described more fully below. The event to patient initiated processing string, while used to perform heretofore unavailable and highly integrated processing in the present context, may be generally similar to the types of events which drive current medical service provision.

A data processing system may generally monitor a wide range of data parameters, including the very state of the data (static or changing) to detect when new data becomes available. The new data may become available by updating patient records, accessing new information, uploading or downloading data to and from the various controllable and prescribable resources and data resources, and so forth. Where desired, the programs executed by the data processing system may initiate processing based upon such changes in the state of data. By way of example, upon detecting that a patient record has been updated by a recent patient contact or the availability of clinical or non-clinical data, the processing string may determine whether subsequent actions, notifications, reports or examinations are in order. Similarly, the programs carried out by the data processing system may automatically initiate certain processing. Such system-initiated processing may be performed on a routine bases, such as predetermined time intervals or at the trigger of various system parameters, such as inventory levels, newly-available data or identification of relationships between data, and so forth.

A particularly powerful aspect of the highly integrated approach of the present technique resides in the fact that, regardless of the initiating source of the processing, various processing strings may result. The processing strings, while generally aligned with various initiating sources, may result from other initiating sources and executed programs. For example, a user or context string may include processing which accesses and returns processed information to respond precisely to a user-initiated processing event, or in conjunction with the particular context within which a user accesses the system. However, such processing strings may also result from event or patient initiated processing, data state changes, and system-initiated processing. Moreover, it should be noted that several types of specific strings may follow within the various categories. For example, the user or context string may include specific query-based processing, designed to identify and return data which is responsive to specific queries posed by a user. Alternatively, user or environment-based strings may result in which data accessed and returned is user-specific or environment-specific. Examples of such processing strings might include access and processing of data for analysis of interest to specific users, such as specific types of clinicians or physicians, financial institutions, and insurance companies.

As a further example of the various processing strings which may result from the initiating source processing, event strings may include processing which is specific to the medical event experienced by a patient, or to events experienced in the past or which may be possible in future. Thus, the event strings may result from user initiation, event or patient initiation, data state change initiation, or system initiation. In a typical context, the event string may simply follow the process of a medical event or symptom being experienced by a patient to access information, process the information, and provide suggestions or diagnoses based upon the processing. As noted above, the suggestions may include the performance of additional processing or analysis, the acquisition of additional information, both automatically and with manual assistance, and so forth.

A general detection string might also be initiated by the various initiating sources. In the present context, the general detection string may include processing designed to identify relevant data or relationships from the data entities which were not specifically requested by a user, event, patient, data state change or by the system. Such general detection strings may correlate new data in accordance with relationships identified by the data processing system or IKB. Thus, even where a patient or user has not specifically requested detection of relationships or potential correlations, programs executed on the data entities may nevertheless execute comparisons and groupings to identify risks, potential treatments, financial management options and so forth under a general detection string. Finally, a system processing string may be even more general in nature. The system string may be processed with the goal of discovering relationships between data available from the various resources and the classified data entities. These new relationships may be indicative of new ways to diagnose or treat patients such as based upon recognizable trends or correlations, analysis of success or failure rates, statistical analyses of patient care results, and so forth. As in the previous examples, the system string may be initiated in various manners, including at the automatic initiation of the system, but also with changes in data state, upon the occurrence of newly detected medical event or by initiation of the patient, or by a specific request of a user.

In accordance with one aspect of the present technique, enhanced processing of patient data is provided by coordinating data collection and processing directly from the patient with data stored in the IKB. For the present purposes, it should be borne in mind that the IKB may be considered to include data entities and information within various resources themselves, or processed information resulting from analysis of such raw data. Moreover, in the present context the IKB is considered to include data which may be stored in a variety of locations both within an institution and within a variety of institutions located in a single location or in quite disparate locations. The IKB may, therefore, include a variety of coordinated data collection and repository sites.

The patient information and other data entities included in the IKB may result from any one or more of the types of resources described above. Moreover, as also described above, patient information may result from analysis of this type of data in conjunction with other generally available data in the data resources, such as different graphic information, proprietary or generally accessible databases, subscription databases, digitized reference materials, and so forth. However, the information is particularly useful when coordinated with a patient contact, such as a visit to a physician or facility. Different distinct classes of action may be grouped logically, such as patient interactions, system interactions, and report or education-type actions. These action classes may be further considered, generally, as inputs, processing, and outputs of the overall system. Moreover, the action classes may be thought of as occurring by reference to a patient contact, such as an on-site visit. In this sense, the actions may be generally classified as those taken prior to a visit or contact, those taken during a contact, and post-contact actions.

By collection of certain patient information at these various stages of interaction, information from the IKB may be extremely useful in providing enhanced diagnosis, analysis, patient care, and patient instruction. In particular, several typical scenarios may be envisaged for the collection and processing of data prior to a patient contact or on-site visit.

As an example of the type of information which may be collected prior to a patient contact, sub-classes of actions may be performed. By way of example, prior to a patient visit, a record for the patient contact or medical event (e.g. the reason for the visit) may be captured to begin a new or continuing record. Such initiation may begin by a patient phone call, information entered into a website or other interface, instant messages, chat room messages, electronic messages, information input via a web camera, and so forth. The data relating to the record may be input either with human interaction or by automatic prompting or even through unstructured questionnaires. In such questionnaires, the patient may be prompted to input a chief complaint or symptoms, medical events, and the like, with prompting from voice, textual or graphical interfacing. In one exemplary embodiment, for example, the patient may also respond to graphical depictions of the human body, such as for selection of symptomatic region of the body.

Other information may be gathered prior to the patient contact, such as biometric information. Such information may be used for patient identification and/or authentication before data is entered into the patient record. Moreover, remote vital sign diagnostics may be acquired by patient input or by remote monitors, if available. Where data is collected by voice recording, speech recognition software or similar software engines may identify key medical terms for later analysis. Also, where necessary, particularly in emergency situations, residential or business addresses, cellular telephone locations, computer terminal locations, and the like can be accessed to identify the physical location of a patient. Moreover, patient insurance information can be queried, with input by the patient to the extent such information is known or available.

Based upon the patient interactions, various system interactions may be taken prior to the patient visit or contact. In particular, as the patient-specific data is acquired, data is accessed from the IKB (including the various resources) for analysis of the patient information. Thus, the data may be associated or analyzed to identify whether appointments for visits are in order, if not already arranged, and such appointments may be scheduled based upon the availability of resources and facilities, patient preferences and location, and so forth. Moreover, the urgency of such scheduled appointments may be assessed based upon the information input by the patient.

Among the various recommendations which may be made based upon the analysis, pre-visit imaging, laboratory examinations, and so forth may be recommended and scheduled to provide the most relevant information likely to be needed for efficient diagnosis and feedback during or immediately after the patient visit. Such recommendations may entail one or more of the various types of resources described above, and one or more of the modalities within each resource. The various information may also be correlated with information in the integrated knowledge base to provide indications of potential diagnoses or relevant questions and information that can be gathered during the patient visit. The entire set of data can then be uploaded to the integrated knowledge base to create or supplement a patient history database within the IKB.

As a result of the uploading of data into the IKB, various types of structured data may be stored for later access and processing. For example, the most relevant captured patient data may be stored, in a structured form, such as by classes or fields which can be searched and used to evaluate potential recommendations for the procedures used prior to the medical visit, during the visit and after the visit. The data may be used, then for temporal analysis of changes in patient conditions, identification of trends, evaluation of symptoms recognized by the patient, and general evaluation of conditions which may not even be recognized by the patient and which are not specifically being complained of. The data may also include, and be processed to recognize, potentially relevant evidence-based data, demographic risk assessments, and results of comparisons and analyses of hypothesis for the existence or predisposition for medical events and conditions.

Following the system interaction, and resulting from the system interaction, various output-type functions may be performed by the system. For example, patient-specific recommendations may be communicated to the patient prior to the patient contact. These recommendations may include appointments for the contact or for other examinations or analyses, educational information relating to such procedures, protocols to be followed prior to the procedures (e.g. dietary recommendations, prescriptions, timing and duration of visits). Moreover, the patient information may be specifically tailored or adapted to the patient. In accordance with one aspect of the technique, for example, educational information may be conveyed to the patient in a specific language of preference based upon textual information available in the IKB and the language of preference indicated by the patient in the patient record. Such instructions may further include detailed data, such as driving or public transportation directions, contact information (telephone and facsimile numbers, website addresses, etc.). As noted above, actions may include ordering and scheduling of exams and data acquisition.

A further output action which may be taken by the system prior to and on-site visit might include reports or recommendations for clinicians and physicians. In particular, the reports may include output based upon the indications and designation of symptoms experienced by the patient, patient history information collect, and so forth. The report may also include electronic versions of images, computer-assisted processed (e.g. enhanced) images, and so forth. Moreover, such physician reports may include recommendations or prioritized lists of information or examinations which should be performed during the visit to refine or rule out specific diagnoses.

The process may continue with information which is collected by patient interaction during a contact, such as an on-site visit. In a present example, the information collected at the time of the contact might begin with biometric information which, again can be used for patient identification and authentication. The visit may thus begin with a check-in process in which the patient is either registered on-site or pre-registered off-site prior to a visit. Coordinated system interactions may be taken during this time, such as automatic access to the patient record established during the pre-visit phase. Additional information, similar to or supplementing the information collected prior to the visit may then be entered into the patient record. Patient conversation and inputs may be recorded manually or automatically during this interview process in preparation for a clinician or physician interview. As before, where voice data is collected, speech recognition engines may identify key medical terms or symptoms which can be associated with information in the IKB to further enhance the diagnosis or treatment. Video data may similarly be collected to assess patient interaction, mental or physical state, and so forth. This entire check-in process may be partially or fully automated to make optimal use of institutional resources prior to actual interview with a clinician, nurse, or physician.

The on-visit may continue with an interview by a clinician or nurse. The patient conversation or interaction may again be recorded in audio or video formats, with complaints, symptoms and other key data being input into the integrated knowledge base, such as for identification of trends and temporal analysis of advancement of a condition or event. Again, and similarly, vital sign information may be updated, and the updated patient record may be evaluated for identification of trends and possible diagnoses, as well as or recommendations of additional medical procedures, as noted above.

The on-site visit typically continues with a physician or clinician interview. As noted above, during the on-site visit itself, analyses and correlations with information in the integrated knowledge base may be performed with reports or recommendations being provided to the physician at the time of the interview. Again, the reports may provide recommendations, such as rank-ordered proposals for potential diagnoses, procedures, or simply information which can be gathered directly from the patient to enhance the diagnosis and treatment. The interview itself may, again, be recorded in whole or in part, and key medical terms recognized and stored in the patient's record for later use. Also during the on-site visit, reports, recommendations, educational material, and so forth may be generated for the patient or the patient care provider. Such information, again, may be customized for the patient and the patient condition, including explanations of the results of examinations, presentations of the follow-up procedures if any, and so forth. The materials may further include general health recommendations based upon the patient record, interaction during the contact and information from the integrated knowledge base, including general reference material. The material provided to the patient may include, without limitation, text, images, animations, graphics, and other reference material, raw or processed, structured video and/or audio recordings of questions and answers, general data on background, diagnoses, medical regimens, risks, referrals, and so forth. The form of such output may suit any desired format, including hard-copy printout, compact disk output, portable storage media, encrypted electronic messages, and so forth. As before, the communication may also be specifically adapted to the patient in a language of preference. The output may also include information on financial arrangements, including insurance data, claims data, and so forth.

The present techniques further facilitate post-contact data collection and analysis. For example, following a patient visit, various patient interactions may be envisaged. Such interactions may include general follow-up questions, symptom updates, remote vital sign capture, and the like, generally similar to information collected prior to the contact. Moreover, the post-contact patient interaction may include patient rating of an institution or care providers, assistance in filing or processing insurance claims, invoicing, and the like. Again, based upon such inputs, data is accessed, which may be patient-specific or more general in nature, from the integrated knowledge base to permit the information to the coordinated with patient records and all other available data to facilitate the follow-up activities, and to generate any reports and feedback both for the patient and for the care provider.

The present technique offers further advantages in the ability of patients to be informed and even manage their own respective medical care. As noted above, the system can be integrated in such a manner as to collect patient data prior to medical contacts, such as office visits. The system also can be employed to solicit additional information, where needed, for such interactions. Furthermore, the system can be adapted to allow specific individualized patient records to be maintained that may be controlled by the individual patient or a patient manager.

In this application, the IKB and the data domain definition and entity mapping techniques described above may be referred to generally as a patient-management system, which at least partially includes features of the IKB and other techniques described above. A patient provides patient data that is incorporated into data entities as described above. The patient data may be provided in any suitable manner, such as via hard copies, analysis of tissue samples, input devices at institutions or clinics, or input devices which are individualized for the patient. Such input devices may include, for example, devices which are provided to, worn by, implanted in, or directly implemented by the patient as at the patient's home or place of employment. Thus, the patient data 346 may be provided by mobile samplers (e.g. for blood analysis), sensing systems for physiological data (e.g. blood pressure, heart rate, etc.). The patient data may be stored locally, such as within the sensing device or within a patient computer or workstation. Similarly, the patient data may be provided either at the prompting of the patient or through system prompting, such as via accessible Internet web pages. Further, patient data may be extracted from external resources, including the resources of the integrated knowledge base as described more fully below. Thus, the patient data, in implementation, may be exchanged in a bi-directional fashion such that the patient may provide information to the record and access information from the record. Similarly, the patient may manage input to the record of data from outside resources as well as manage access to output of the record to outside resources.

The patient data is exchanged with other elements of the system via a patient network interface. The patient network interface may be as simple as a web browser, or may include more sophisticated management tools that control access to, validation of, and exchange of data between the patient and the outside resources. The patient network interface may communicate with a variety of other components, such as directly with care providers as indicated at reference numeral. Such care providers may include primary care physicians, but may also include institutions and offices that store patient clinical data, and institutions that store non-clinical data such as insurance claims, financial resource data, and so forth. The patient network interface may further communicate with a reference data repository where data entities are stored. The repositories may be useful by the patient network interface for certain processing functions carried out by the interface, such as comparison of patient data to known ranges or demographic information, integration into patient-displayed interface pages of background and specific information relating to disease states, care, diagnoses and prognoses, and so forth. The patient network interface where necessary, may further communicate with a translator or processing module which completely or partially transform the accessed data or the patient data for analysis and storage as data entities for identification, analysis and classification. Again, the translator and processing functions may be bi-directional such that they may translate and process both data originating from the patient and data transferred to the patient from outside resources.

An integrated patient record module may then be designed to generate an integrated patient record. As used in the present context, the integrated patient record may include a wide range of information, both acquired directly from the patient, as well as acquired from institutions which provide care to the patient. The record may also include data derived from such data, such as resulting from analysis of raw patient data, image data, and the like both by automated techniques and by human care providers, where appropriate. Similarly, the integrated patient record may include information incorporated from reference data repositories. The integrated patient record module preferably stores some or all of the integrated patient record in one or more data repository. The resulting information may form one or multiple data entities that can be later accessed and analyzed.

As noted above, the present technique facilitates creation of an integrated patient record which may include a wide range of patient data. In practice, the integrated patient record, or portions of the patient record, may be stored at various locations, such as at a patient location, at individual care providers (e.g. with a primary care physician), or within a data repository accessed by the integrated patient record module. It should also be noted that some or all of the functionality provided by the patient network interface, the translator and processing module and the integrated patient record module may be local or remote to the patient. That is, software for carrying out the creation and maintenance of the patient record may be stored direct at a patient terminal, or may be fully or partially provided remotely, such as through a subscription service. Similarly, the patient record repository 358 may be local or remote from the patient.

The integrated patient record module also may be designed to communicate with the IKB and the components described above for its creation. As described above, the present technique permits the identification, analysis and classification of data entities for incorporation into the IKB or from at-large resources. Again, such data entities may be internal to specific institutions. The techniques also permit data from the patient to be uploaded to such resources and institutions. For example, the integrated patient record, fully or in part, may be stored generally within the IKB to facilitate access by care providers, for example. The record may also be stored within individual institutions, such as within a hospital or clinic which has or will provide specific patient care.

The access to specific information and data entities, and the creation of records may be controlled and regulated more directly by a patient. That is, the present techniques serve as an enabler for empowering the patient with respect to proactive management of medical records. Such interaction may take the form of patient-controlled access to portions of the patient record provided to specific care providers. Similarly, the system offers the potential for improving the education of the patient as regards to general questions as well as specific clinical and non-clinical issues. The system also provides a powerful tool for accessing patient data, including raw data, processed data, links, updates, and so forth which may be used by care providers for identifying and tracking patient conditions, scheduling patient care visits, and so forth. Such functions may be provided by “push” or “pull” exchange techniques, such as on a timed basis, or through notifications, electronic messages, wireless messages, and so forth. Direct interaction with the patient may include, therefore, uploading of patient data, downloading of patient data, prescription reminders, office visit reminders, screening communications, and so forth. Moreover, the integration of the patient data with other functionality and data from other resources permits the integrated patient record to be created and stored periodically or in advance of specific needs by the patient or by an institution, or compiled at the time of a specific query by linking to and accessing data for response to the query.

The present techniques, by virtue of the high degree of integration of the data entities and their association in the relevant domain as described above, provide a powerful tool for development of predictive models, both clinical and non-clinical in nature. In particular, data entities and their analysis can be identified and classified to improve patient care by virtue of predictive model development. The development of such predictive models can be fully or partially automated, and such modeling may serve to adapt certain computer-assisted functions of the types described above.

For example, a predictive modeling system may be built upon or compliment the IKB and mapping and classification functions described above. The predictive modeling system may draw upon the resources, both data resources and controllable and prescribable resources, as well as upon any IKB data entities, which again may be centralized or distributed in nature. The system may then rely upon software such as data mining and analysis modules designed to extract data from the various resources, knowledge bases and databases, and to identify relationships between the data useful in developing predictive models. The analysis performed by the data mining and analysis modules may be initiated in any suitable manner, including any or all of the initiating events outlined above. Once processing is initiated, the modules search for and identify data which may be linked to specific disease states, medical events, or to yet unidentified or unrecognized disease states or medical events. Moreover, the modules may similarly seek non-clinical data for development of similar models, such as for prediction of resource needs, resource allocation, insurance rates, financial planning, and so forth. It should be noted that the data mining and analysis functions performed by the modules may operate on “raw” data entities from the resources and databases (again both clinical and non-clinical), as well as on filtered, validated, reduced-dimension, and similarly processed data from any one of these resources. Moreover, initiation of such processing, or validation of data may be provided by an expert, such as a clinician.

Based upon the mining an analysis performed by modules 366, a predictive model development module 370 further acts to convert the data and analysis into a representative model that can be used for diagnostic, planning, and other purposes. In the clinical context, a wide range of model types may be developed, particularly for refinement of computer-assisted processes referred to above. As noted above, these processes, referred to here in as CAX processes, permit powerful computer-assisted work flow such as for acquisition, processing, analysis, diagnostics, and so forth. The methodologies employed by the predictive model development module 370 may vary depending upon the application, the data available, and the desired output. In presently contemplated embodiments, for example, the processing may be based upon regression analysis, decision trees, clustering algorithms, neural network structures, expert systems, and so forth. Moreover, the predictive model development module may target a specific disease state or medical condition or event, or may be non-condition specific. Where data is known to relate to a specific medical condition, for example, the model may consist in refinement of rules and procedures used to identify the likelihood of occurrence of such conditions based upon all available information from the resources and knowledge base. More generally, however, the data mining and analysis functions, in conjunction with the model development algorithms, may provide for identification of disease states and relationships between these disease states and available data which were not previously recognized.

In applications where the predictive model development module is adapted for refinement of a computer-assisted process CAX, the model may identify or refine parameters useful in carrying out such processes. The output of the module may therefore consist of one or more parameters identified as relating to a specific condition, event or diagnosis. Outputs from the predictive model development module, typically in the form of data relationships, may then be further refined or mapped onto parameters available to and used by the CAX processes. In a presently contemplated embodiment, therefore, a parameter refinement function is provided wherein parameters utilized in the CAX processes are identified, and “best” or optimized values or ranges of the values are identified. The parameters and their values or ranges are then supplied to the CAX process algorithms for future use in the specific process.

It should be noted that various functions performed and described above in the predictive modeling system may be performed on one or more processing systems, and based upon various input data enities. Thus, as mentioned above, the IKB and therefore the data available for predictive model development is inherently expandable such that models may be developed differently or enhanced as improved or additional information is available. It should also be noted that the various components of the system may provide for highly interactive model development. That is, various modules and functions may influence one another to further improve model development.

By way of example, where a predictive model is developed by a module based upon specific data entities classified as described above, the model development module may identify that additional or complimentary data would also be useful in improving the performance of the CAX processes. The model development module may then influence the data mining and analysis function based upon such insights. Similarly, the identification of parameters and parameter optimization carried out in the parameter refinement process can influence the predictive model development module. Furthermore, the results of the CAX process can similarly affect the predictive model development module, such as for development or refinement of other CAX processes.

The latter possibility of interaction between the components and functions is particularly powerful. In particular, it should be recognized that the predictive model development module may, in some respects, itself serve as a CAX process, such as for recognizing relationships between available data and matching such relationships to potential disease states, events, resource needs, financial considerations, and so forth. The process is not limited to any particular CAX process, however. Rather, although model development may focus on the diagnosis of a disease state, for example, the output of the CAX process (e.g. computer-assisted diagnosis or detection) may give rise to improvements in processing and modeling of desired processing of data. Similarly, the results of the CAX process in processing may lead to recognition of improvements in a model implemented for computer-assisted acquisition (CAA) of data. Other computer-assisted processes, including computer-assisted assessment (CAAX) of health or financial states, prognoses, prescriptions, therapy, and other decisions may similarly be impacted both by the predictive model development module, and by feedback from refined other processes.

In use, the developed or improved model will typically be available for remote processing or may be downloaded to systems, including computer systems, medical diagnostic imaging equipment, and so forth, which employ the model for improving data acquisition, processing, diagnosis, decision support, or any of the other functions served by the CAX process. During such implementation, and as described above, the implementing system may access the IKB or the originating resources themselves to extract the data entities needed for the CAX process.

Within the predictive model development module several functions may be resident and carried out either on a routine basis or as specifically programmed or initiated by a user or by the system. For example, based upon data entities available (i.e. acquired or extracted from the resources and classified as described above), the module will typically identify relationships between available data. The relationships may be based upon known interactions between the data, or based upon identification algorithms as noted above (e.g. regression analysis, decision trees, clustering algorithms, neural networks, expert input, etc.). Moreover, it should be noted that the relationship identification may be based on any available data. That is, the data may be most usefully employed in the system when considered separate from its type, modality, practice area, and so forth. By way of example, clinical data may be employed from imaging systems and used in conjunction with demographic information and with histological information on a particular patient. The data may also incorporate non-patient specific (e.g. general population) data which may be further indicative of risk or likelihood of a particular disease state, and so forth. Based upon the identified relationships, rule identification is carried out. Such rules may include comparisons, Boolean relationships, regression equations, and so forth used to link the various items of data or input in the identified relationships.

A wide range of models may be developed by the foregoing techniques. In a clinical context for example, different types of data as described above maybe accessible to the CAX algorithms, such as image data, demographic data, and non-patient specific data. By way of example, a model may be developed for diagnosing breast cancer in women residing in a specific region of a country during a specific period of years known to indicate an elevated risk of such conditions. Additional factors that may be considered where available, could be patient history as extracted from questionnaires completed by the patient (e.g. smoking habits, dietary habits, etc.).

As a further example, and illustrating the interaction between the various processes, a model for acquiring data or processing data may be influenced by a computer-assisted diagnosis (CADx) algorithm. In one example, for example, the output from a therapy algorithm with highlighting of abdominal images derived from scanned data may be altered based upon a computer-assisted diagnosis. Therefore, the image data may be acquired or processed in relatively thin slices for a lower abdomen region where the therapy algorithm called for an appendectomy. The rest of the data may be processed in a normal way with thicker slices. Thus, not only can the CAX algorithms of different focus influence one another in development and refinement of the predictive models, but data of different types and from different modalities can be used to improve the models for identification and treatment of diseases, as well as for non-clinical purposes.

While only certain features of the invention have been illustrated and described herein, many modifications and changes will occur to those skilled in the art. It is, therefore, to be understood that the appended claims are intended to cover all such modifications and changes as fall within the true spirit of the invention.

1. A computer-implemented method for analyzing medical data comprising:
accessing data entities classified based upon a data domain definition including a plurality of classification axes and a plurality of classification labels for each axis, and upon corresponding attributes of the data entities; and
analyzing the data entities to determine a relationship between the data entities for use in a health care decision.

2. The method of claim 1, wherein the decision includes a diagnosis, recommended course medical care for an individual patient.

3. The method of claim 1, wherein the relationship includes a health condition in a population.

4. The method of claim 1, wherein analyzing the data entities includes applying computer-aided diagnosis algorithm configured to recognize a feature of interest in a data entity related to a health condition of a patient.

5. The method of claim 1, wherein analyzing the data entities includes applying computer-aided data acquisition algorithm or a computer-aided data processing algorithm configured to acquire additional data or process data to permit recognition a feature of interest in a data entity related to a health condition of a patient.

6. The method of claim 1, wherein the data entities include electronic patent records.

7. The method of claim 1, wherein at least one of the axes, labels or attributes includes a genetic indicator of a health condition.

8. The method of claim 1, wherein at least one of the axes, labels or attributes includes a health condition and a symptom of the condition.

9. The method of claim 1, wherein the attributes include at least two different types of attributes selected from a group consisting of text attributes, image attributes, audio attributes, video attributes, and waveform attributes.

10. The method of claim 9, comprising searching for a data entity by reference to a text attribute and returning an image data entity in response to the search.

11. The method of claim 1, wherein at least data representative of classification of the data entities is stored in an integrated knowledge base.

12. The method of claim 1, wherein the health care decision altering a parameter of acquisition, processing, reconstruction, analysis, display or retrieval of medical image data.

13. The method of claim 1, wherein the data entities are classified from a plurality of data resources and a plurality of controllable and prescribable resources.

14. The method of claim 1, wherein the data entities include medical image data acquired via at least one imaging modality including X-ray systems, MRI systems, ultrasound systems, PET systems, and CT systems.

15. The method of claim 1, further comprising presenting a graphical representation of the analysis.

16. A computer-implemented method for analyzing medical data comprising:
accessing data entities classified based upon a data domain definition including a plurality of classification axes and a plurality of classification labels for each axis, and upon corresponding attributes of the data entities, the data entities being classified from a plurality of data resources and a plurality of controllable and prescribable resources;
analyzing the data entities to determine a relationship between the data entities; and
making a health care recommendation based upon the analysis.

17. The method of claim 16, wherein the controllable and prescribable resources include medical image resources including X-ray systems, MRI systems, ultrasound systems, PET systems, and CT systems.

18. The method of claim 16, wherein the controllable and prescribable resources include at least electrical resources, imaging resources, laboratory resources, histologic resources, financial resources, and demographic data resources.

19. The method of claim 16, wherein the controllable and prescribable resources include clinical examination resources for acquiring patient data from patient tissues.

20. The method of claim 16, wherein the recommendation includes a diagnosis or course medical care for an individual patient.

21. The method of claim 16, wherein the relationship includes a health condition in a population.

22. A computer program for analyzing medical data comprising:
at least one machine readable medium; and
computer code stored on the at least one machine readable medium including code for accessing data entities classified based upon a data domain definition including a plurality of classification axes and a plurality of classification labels for each axis, and upon corresponding attributes of the data entities, and analyzing the data entities to determine a relationship between the data entities for use in a health care decision.

23. The computer program of claim 22, wherein the code for analyzing the data entities includes a computer-aided diagnosis algorithm configured to recognize a feature of interest in a data entity related to a health condition of a patient.
